(19) United States
(12) Patent Application Publication
(10) Pub. No.: US 2008/0165702 A1
(43) Pub. Date: Jul. 10, 2008

(54) Communications System, Method for Controlling a Communications System, Network Access Device and Method for Controlling A Network Access Device

(75) Inventors: Maik Bienas, Braunschweig (DE); Martin Hans, Bad Salzdetfurth (DE); Achim Luft, Brauschweig (DE); Norbert Schwagmann, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/813,617

(22) PCT Filed: Jan. 10, 2006
(86) PCT No.: PCT/DE2006/000022

§ 371 Date: Dec. 28, 2007

(30) Foreign Application Priority Data
Jan. 10, 2005 (DE) 102005001123.3

(51) Int. Cl. H04L 12/28

(52) U.S. Cl. 370/254

(57) ABSTRACT

Communications system having first, second, and third communications networks, a subscriber device, and a network access device having a network layer address. The network access device permits access by the first communications network to the third communications network and access by the second communications network to the third communications network. There is a communications link between the subscriber device and the third communications network via the first communications network and the network access device, wherein the network layer address is used during the transmission of data via the first communications link. The network access device has a control device that releases the first communications link and sets up a second communications link between the subscriber device and the third communications network via the second communications network and the network access device. The network layer address of the network access device is used during the transmission of data via the second communications link.

### CROSS-REFERENCE TO RELATED APPLICATION

This application is a continuation of International Patent Application Serial No. PCT/DE2006/000022, filed Jan. 10, 2006, which published in German on Jul. 13, 2006, as WO/2006/072240, and is incorporated herein by reference in its entirety.

### FIELD OF THE INVENTION

The invention relates to a communications system, a method for controlling a communications system, a network access device and a method for controlling a network access device.

### BACKGROUND OF THE INVENTION

In the last few years, people have come to take for granted the possibility of being able to make mobile telephone calls virtually anywhere.

In addition, for a short time now it has been possible to use packet switched (communications) services at high data rates on a mobile basis.

The 2nd generation mobile radio systems which are typically used at present, for example, mobile radio systems according to the GSM (global system of mobile communications) standard, are principally provided for mobile radio voice connections and are not very suitable for transmitting large quantities of data due to the low data transmission rates which such a mobile radio system makes available.

A number of mobile radio communications systems have been developed and are being developed which are capable of making available packet switched services at a high data rate.

For example, work is being carried out on the development and standardization of the UMTS (Universal Mobile Telecommunication System) standard within the scope of the 3rd Generation Partnership Project (3GPP).

A UMTS communications system, that is to say a communications system according to the UMTS standard, provides users with various line switched services and packet switched services and will be available in the near future over wide areas of Europe and elsewhere.

In addition, what are referred to as “Wireless Local Area Networks” (WLAN) are known. WLANs are designed in particular for the radio transmission of packet switched services.

WLANs permit data to be transmitted at higher data rates than UMTS communications systems but do not permit the mobility of users to the same degree as is made possible by UMTS communications systems.

WLANs are specified, for example, by the standard IEEE 802.11 and the standard HIPERLAN or HIPERLAN/2.

Future (mobile radio) subscriber devices are expected to be configured to use 2nd generation mobile radio communications systems as well as UMTS communications systems and WLAN, that is to say to set up communications links to UMTS communications systems and WLAN and to transmit data by means of the communications links.

Accordingly, the situation will frequently occur in which a user of a subscriber device is using a packet switched service by means of a communications link to a WLAN and during the communications link moves out of the coverage area of a WLAN radio cell, that is to say the geographical area in which the WLAN can be used by means of the subscriber device.

Typically, in this case the communications link to the WLAN would be ended, even if there is supply by a UMTS communications system outside the WLAN radio cell, that is to say the subscriber device could continue to use the packet switched service by means of a communications link to the UMTS communications system.

For the subscriber device to be able to continue using the packet switched service by means of a communications link to the UMTS communications system, it is necessary to change over the communications system from the WLAN to the UMTS communications system so that there is always a communications link to the WLAN or a communications link to the UMTS communications system.

Cooperation between UMTS communications systems and WLAN is being standardized by the standardization working party of the 3GPP with the designation “3GPP System to WLAN Interworking”.

The degree of cooperation between UMTS communications systems and WLAN has been divided into 6 stages and 6 scenarios, referred to as scenario 1 to scenario 6, have been defined. Scenario 1 has the lowest degree of cooperation and scenario 6 has the greatest degree of cooperation. In scenario 4 and above, that is to say according to scenario 4, scenario 5 and scenario 6, there is the possibility of an inter-system handover, that is to say a change of communications system between UMTS communications systems and WLAN (see 3GPP TSG-SA, TR 22.934, Feasibility Study On 3GPP System to Wireless Local Area Network Interworking, section 6.5).

Scenario 3 is being specified at present. Procedures for an inter-system handover have not yet been specified.

FIG. 1 shows a UMTS communications system 100 for making available packet switched services.

A subscriber device 101 is connected to a UMTS radio network 103 by means of a first base station 102 which is referred to as NodeB in the UMTS standard.

The first base station 102 is the radio interface between the subscriber device 101 and the UMTS radio network 103, and it permits the transmission of UMTS radio signals.

The first base station 102 is connected to an RNC (Radio Network Controller) 104. The RNC 104 essentially has the functions which relate to the control of the air interface such as, for example, the allocation of radio resources during a communications link setup.

It is possible to connect further base stations to the RNC 104, for example a second base station 110 here.

The Internet protocol (IP) is used to transmit data packets. An SGSN (Serving GPRS (General Packet Radio Service) Support Node) 105 connects, viewed illustratively from the point of view of the IP, the subscriber device 101 with the UMTS radio network 103, and it makes available the functionality of a router. The SGSN 105 also serves to authenticate users for the management of mobility.

By means of a GGSN (Gateway GPRS Support Node) 106 the UMTS network 103 is connected to external packet based communications networks, for example the Internet 107 here. The GGSN 106 also makes available the functionality of a router.

The GGSN is also connected to an IMS (IP Multimedia Subsystem) 108, that is to say a communications system according to the IMS standard.

An IMS is a packet based communications system. The IMS standard has been developed in order to be able to offer services which are typical of a line switched transmission, such as for example, telephony.

An HLR (Home Location Register) 109 contains all the data which are necessary to set up a communications link and to authenticate the user of the subscriber device 101.

FIG. 2 shows a communications system 200 with a WLAN access network 203.

A subscriber device 201 is connected to the WLAN access network 203 by means of a first access point (AP) 202. The first access point 202 serves as a radio interface and permits the transmission of radio signals.

The access point 202 and possible further access points, for example a second access point 204 here, are connected to an access router (AR) 205. The access router 205 is responsible for the control of handover between the connected access point 202, 204, and it connects the subscriber device 201 to the Internet 206 and to an AAA (Authentication, Authorization and Accounting) server 207.

The access router 205 makes available the functionality of a router.

The AAA server 207 serves to authenticate and check the authorization of the users.

In addition, the AAA server 207 generates the data used to register charges for communications links.

FIG. 3 shows a communications system 300 with a WLAN/3G interworking network 310.

The WLAN/3G interworking network 310 is constructed according to the 3GPP standard for scenario z3.

The WLAN/3G interworking network 310 connects a UMTS communications system 311, which has the network architecture explained with reference to FIG. 1, to a WLAN communications system 312 which has the network architecture explained with reference to FIG. 2.

The UMTS communications system 311 has, as described with reference to FIG. 1, base stations 302, 303, which are connected by means of an RNC 304 to an SGSN 305, a GGSN 306 which is connected to the SGSN 305, the Internet 307, an IMS 308 and an HLR 309.

The WLAN communications system 312 has, as described with reference to FIG. 2, access points 313, 314 and a subscriber device 315 which is connected to an access router 316 by means of one of the access points 313, 314.

The communications system 300 permits the subscriber device 315 to access, by means of the WLAN access network 312, packet switched (communications) services which are made available by means of the UMTS communications network 311, for example, access to the IMS 308.

If the user of the subscriber device 315 would like to use these services, authentication and authorization by means of an AAA server 316 of the WLAN/3G Interworking network 310 are necessary.

An AAA server, which the WLAN access network 312 possibly has, cannot be used for this.

A PDG (Packet Data Gateway) 317 permits access to the Internet 307 and to the IMS 308, and makes available the functionality of a router.

In order to register charges for communications links, the AAA server 316 is connected to the PDG 317.

A WAG (WLAN Access Gateway) 318 has essentially the function of making available a communications link to the home UMTS communications network (not shown) of a user of a subscriber device (not shown) if a communications link is provided by the subscriber device to the UMTS communications network 311 and the latter is a visited UMTS communications network and not the home UMTS communications network of the user.

For this purpose, the WAG 318 has a communications link to the PDG of the home UMTS communications system (not shown).

The possibility of communicating with the home UMTS communications system by means of a visited UMTS communications system is referred to as roaming.

The WAG 318 makes available the functionality of a router.

The GPRS (General Packet Radio Service) communications standard is disclosed in 3GPP TSG-SA TS 23.060, General Packet Radio Service (GPRS); Service description; Stage 2.

A method for operating a radio communications network by means of which security problems with wireless data transmission, in particular when changing between LAN communications networks and UMTS communications networks, can be solved by using a key which is exchanged between a mobile radio device and a node of the communications network is disclosed in US 2003/0031151 A1.

A method for handover of a mobile radio device between different access networks is disclosed in AU 200135071 A1, in which method a logic interface assigns IP addresses to the communication between the mobile radio device and a physical interface layer.

WO 02/15598 discloses a communications system in which a terminal is connected to different communications networks of the communications system, and in particular can use communications services by means of the different communications networks by means of an interface.

A method for transmitting data in which some of the data to be transmitted is transmitted by means of a secure interface and the remaining part of the data to be transmitted is transmitted by means of an interface which is not particularly secured, for example by means of a WLAN, is disclosed in EP 1 284 568 A1.

A method and an architecture for a communications system which permit a vertical handoff, that is to say a handover between different access networks, which, for example, can make available a communications link between a terminal and the Internet, are disclosed in Hyosoon Park, Sunghoon Yoon, Taeyoun Kim, Jungshin Park, Misun Do, Jaiyong Lee “Vertical Handoff Procedure and Algorithm between IEEE 802.11 WLAN and CDMA Cellular Network,” Lecture Notes in Computer Science (LNCS), No. 2524, pp. 103-112, 2003.

A modification of a PDG which has a GGSN element with functions of a GGSN is disclosed in 3GPP Change Request, 23.234 CR 26.

WO 200390013 discloses a network architecture in which a PLMN (Public Land Mobile Network) is connected to a WLAN by means of an inter-PLMN. A handover between the PLMN and the WLAN is carried out on the basis that the WLAN appears to the PLMN as a further PLMN.

In particular the sequence of registering a subscriber device with a WLAN in accordance with 3GPP is described in 3GPP TS 24.234 TSG-CN; 3GPP System to WLAN Interworking; UE to Network Protocols.

A method in which the current position of a subscriber device is determined and reception conditions are determined on the basis of the current position and using a map is described in EP 1 427 236 A1. By using the reception conditions it is possible to decide, for example, whether a handover is to be carried out.

WO 2004/034592 A2 discloses the mapping of parameters which specify quality requirements, for example QoS (Quality of Service) parameters between different communications systems, so that the quality requirements are specified for each communications system in accordance with the respective communications system.

An interface between a WLAN and a UMTS communications system is described in WO 03/105380 A1, with data which are transmitted from the WLAN to the UMTS communications system being transmitted in such a way that they appear to originate from an SGSN.

WO 2004/043014 A2 discloses a communications system in which a tunnel server is arranged between various communications networks.

A mobile device which is configured to roam between a low-tier wireless network and a high-tier wireless network with a smaller bandwidth but more mobility than the low-tier wireless network is disclosed in DE 103 07 259 A1. Data packets and control signals are transmitted by means of a virtual GPRS support node.

A communications system in which a PDSN (packet data serving node) is arranged between the Internet and an Internet protocol-based communications network is described in US 2004/0008645 A1.

US 2004/0077374 A1 describes a communications system in which communications links can be made available for communications terminals by means of a 3G radio access network or by means of a WLAN.

A method for handover of a communications terminal from a cellular communications network to a WLAN in which an existing Internet protocol communications link is not interrupted is disclosed in WO 2005/008964 A1.

### BRIEF DESCRIPTION OF THE DRAWINGS

Exemplary embodiments of the invention are illustrated in the figures and will be explained in more detail below.

FIG. 1 shows a UMTS communications system for making available packet switched services;

FIG. 2 shows a communications system with a WLAN access network;

FIG. 3 shows communications system with a WLAN/3G interworking network;

FIG. 4 shows a communications system according to an exemplary embodiment of the invention;

FIG. 5 shows a message flowchart according to an exemplary embodiment of the invention;

FIG. 6 shows a message flowchart according to an exemplary embodiment of the invention;

FIG. 7 shows an arrangement of buffers according to an exemplary embodiment of the invention;

FIG. 8 shows an arrangement of buffers according to an exemplary embodiment of the invention;

FIG. 9 shows a message flowchart according to an exemplary embodiment of the invention;

FIG. 10 shows an arrangement of buffers according to an exemplary embodiment of the invention; and

FIG. 11 shows a message flowchart according to an exemplary embodiment of the invention.

### DETAILED DESCRIPTION OF THE INVENTION

The invention is based on the problem of making available an efficient method for a handover of a subscriber device from a first access communications network to a second access communications network.

The is achieved by means of a communications system, a method for controlling a communications system, a network access device and a method for controlling a network access device having the features.

A communications system is made available which has a first communications network, a second communications network, a third communications network, a subscriber device and a network access device to which a network layer address is assigned, wherein the network access device is configured to permit access by the first communications network to the third communications network and access by the second communications network to the third communications network; the communications system has a communications link between the subscriber device and the third communications network by means of the first communications network and by means of the network access device, wherein the network layer address of the network access device is used during the transmission of data by means of the first communications link; and the network access device has a control device which is configured to release the first communications link and to set up a second communications link between the subscriber device and the third communications network by means of the second communications network and by means of the network access device, wherein the network layer address of the network access device is used during the transmission of data by means of the second communications link.

In addition, a method for controlling a communications system, a network access device and a method for controlling a network access device in accordance with the communications system described above are made available.

An idea on which the invention is based can be considered in that the network access device can provide a subscriber device with access to the third communications network both by means of the first communications network and by means of the second communications network, and that when the first communications link is released and the second communications link is set up, which, as it were, corresponds to an (inter-system) handover of the subscriber device from the first communications network to the second communications network, the network layer address of the network access device does not change.

The invention permits, in particular, interruption-free continuation of a (preferably packet switched) communications link which is provided to the third communications network by means of the first communications network, using a communications link which is provided to the third communications network by means of the second communications network.

The invention can be applied in particular for a handover between a WLAN access network and an UMTS communications network, and vice versa, that is to say for a handover from a UMTS communications network to a WLAN access network.

Within the scope of this application it is possible to consider one idea on which the invention is based to be that the two network elements PDG and GGSN are, as it were, joined to form one network element.

The exemplary embodiments described below, which relate to a handover from a WLAN access network to a UMTS communications network and vice versa, can be applied in particular in the case of a conventional UMTS communications network without complex changes to the network elements of the UMTS communications network having to be made. In particular, the invention can be implemented easily, cost-effectively and within a short time for this application.

The further embodiments of the invention, which are described in relation to the communications system made available, apply appropriately also to the method made available for controlling a communications system, the network access device which is made available and the method which is made available for controlling a network access device.

The network layer address of the network access device is preferably specified by means of an APN (Access Point Name) during the transmission of data by means of the first communications link and/or during the transmission of data by means of the second communications link.

The APNs which are used to specify the network layer address may be different, they must merely correspond to the same network layer address.

The APNs are clearly mapped on to the same network layer address, for example, the same IP protocol address.

It is preferred for the first communications network to be a WLAN communications network, that is to say a WLAN, and for the second communications network to be a UMTS communications network, that is to say a UMTS communications system, or for the second communications network to be a WLAN communications network, and for the first communications network to be a UMTS communications network.

The first communications link is thus preferably a WLAN communications link, and the second communications link is preferably a UMTS communications link, or vice versa.

It is also preferred for the subscriber device to have a transmission device which is configured to transmit a message to the network access device which has the request to release the first communications link and to set up the second communications link.

In one embodiment, the message is transmitted to the network access device by means of the first communications network.

This is advantageous since in this case only a small number of changes to the network elements of the UMTS communications network have to be made in order to implement the invention by using an existing UMTS communications network. As a result, the implementation is simple and cost-effective.

In this embodiment, the WLAN communications link is necessary up to the complete setup of the UMTS communications link.

In a second embodiment it is preferred for the message to be transmitted to the network access device by means of the second communications network.

In this way an inter-system handover is still possible if the WLAN communications link is already interrupted, for example because the user has left the coverage area of the WLAN. This is advantageous because the WLAN communications link can thus be used for as long as possible and because an inter-system handover is possible even if there is an unexpected teardown of the WLAN communications link.

The third communications network is preferably the Internet.

In this case, the network layer address of the network access device is an IP address of the network access device.

It is preferred for the network access device to have a WLAN network access device which has the function of a PDG of the WLAN communications network, a UMTS network access device which has the function of a GGSN of the UMTS communications network, and a memory which is accessed by the WLAN network access device and the UMTS network access device.

The two network elements PDG and GGSN are thus, as it were, joined to form one element.

This is advantageous in particular in the case of an inter-system handover between the WLAN communications network and the UMTS communications network because as a result there is no need for signaling between a PDG and a GGSN during the inter-system handover.

In addition, the access point of the subscriber device to the Internet remains the same before and after the inter-system handover, for which reason no new route has to be created in the Internet after the inter-system handover.

It is also preferred for the subscriber device and/or the network access device to have a buffer which is configured to buffer, within the scope of the release of the first communications link and the setup of the second communications link, useful data which are transmitted by means of the first communications link and/or the second communications link.

In this way it is possible to compensate transit time differences which can occur during the switching over from the first communications network to the second communications network, that is to say during the release of the first communications link and the setup of the second communications link, so that no useful data is lost and the correct sequence of the useful data is ensured.

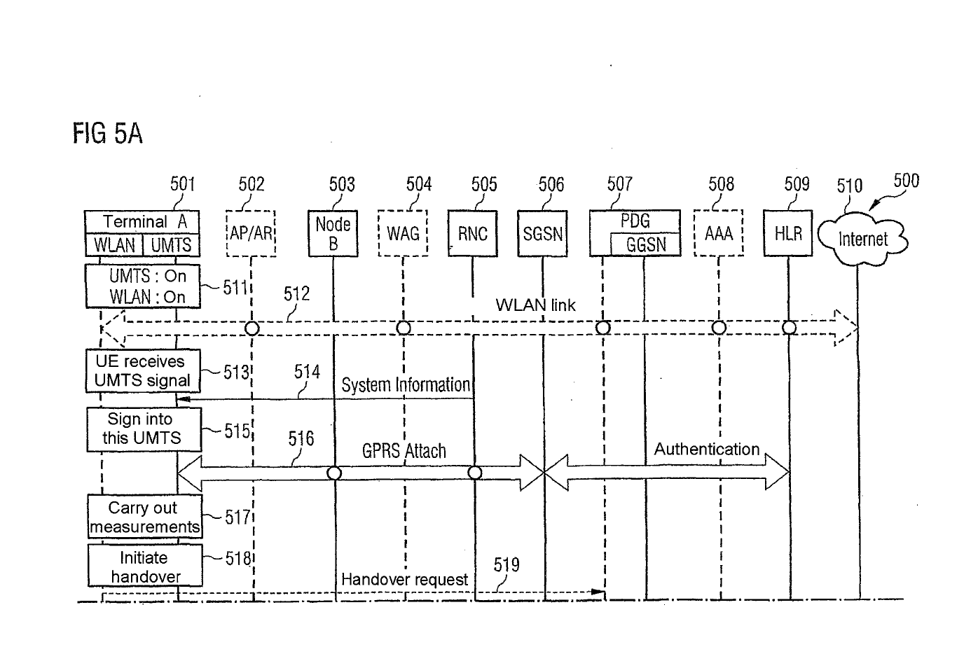

FIG. 4 shows a communications system 400 according to an exemplary embodiment of the invention.

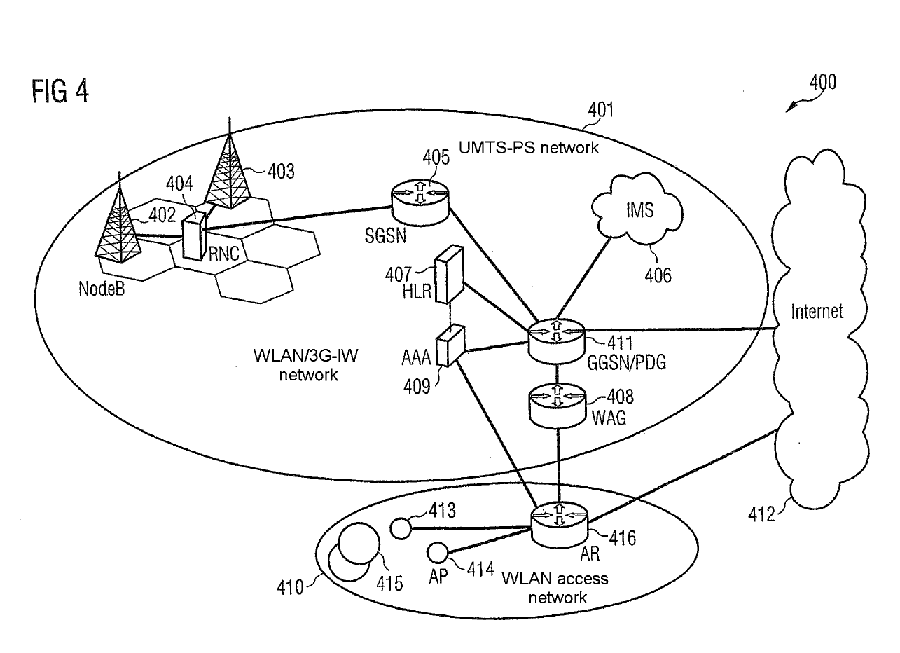

The architecture of the communications system 400 is based on the architecture of a WLAN(3G) interworking network according to scenario 3, as explained above with reference to FIG. 3.

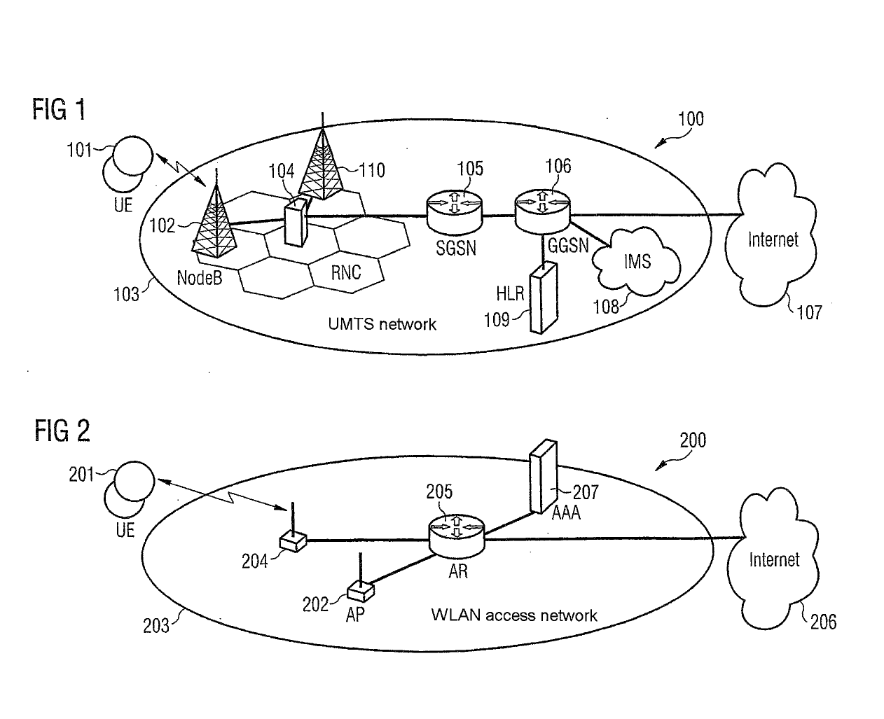

A UMTS communications system 401 has base stations 402, 403 which are connected to an SGSN 405 by means of an RNC 404, an IMS 406, an HLR 407, an AAA server 409 and a WAG 408, each with the functionality described with reference to FIG. 1 and FIG. 3.

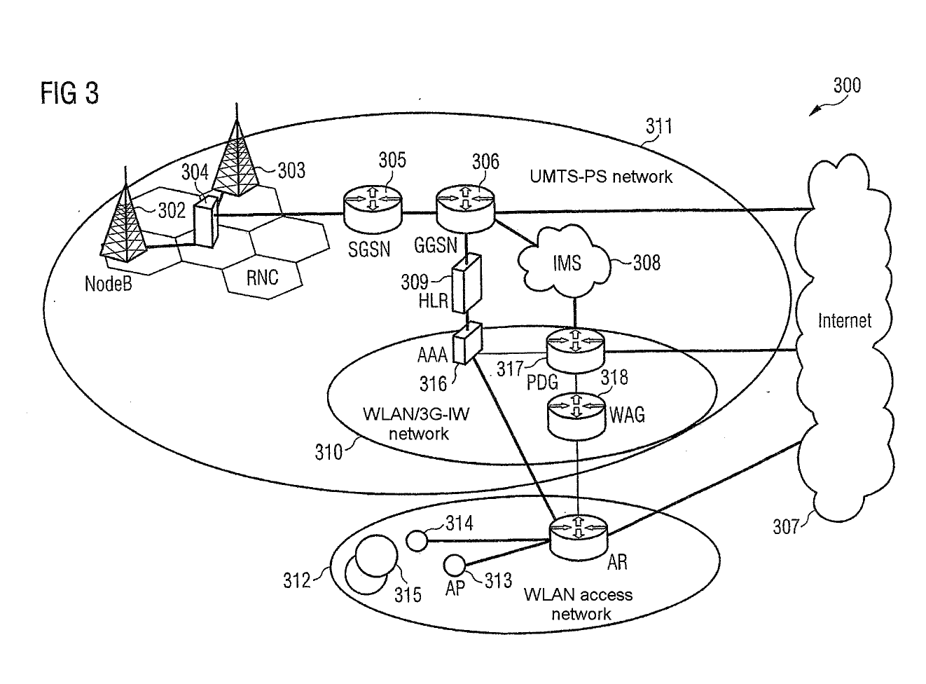

A WLAN communications system 410 has access points 413, 414, and a subscriber device 415 which is connected to an access router 416 by means of one of the access points 413, 414, in each case with the functionality described with reference to FIG. 2 and FIG. 3.

In contrast to the network architecture explained with reference to FIG. 3, the UMTS communications network 401 has a PDG/GGSN 411 instead of a GGSN and a PDG.

The PDG/GGSN 411 makes available the functionality of a GGSN and the functionality of a PDG.

The SGSN 405, the IMS 406, the HLR 407, the AAA server 409, the WAG 408 and the Internet 412 are connected to one another by means of the PDG/GGSN 411.

The mobile subscriber device 415 is equipped with a UMTS transmitter and a UMTS receiver and with a WLAN transmitter and WLAN receiver, that is to say the mobile subscriber device 415 can communicate both with the UMTS communications system 401 and with the WLAN 410.

The UMTS transmitter of the subscriber device 415, the UMTS receiver of the subscriber device 415, the WLAN transmitter of the subscriber device 415 and the WLAN receiver of the subscriber device 415 can be operated simultaneously.

In the text which follows it is assumed that an active packet switched communications link is provided between the subscriber device 415 and a (further) communications terminal (not shown) by means of the WLAN 410.

The communications terminal can, like the subscriber terminal 415, be a mobile subscriber device, or it is a fixed device such as, for example, a PC (Personal Computer).

In addition, in the text which follows it is assumed that the communications terminal is part of the Internet 412.

However, this is not necessary for the invention.

In the text which follows, a handover is always understood to be an inter-system handover.

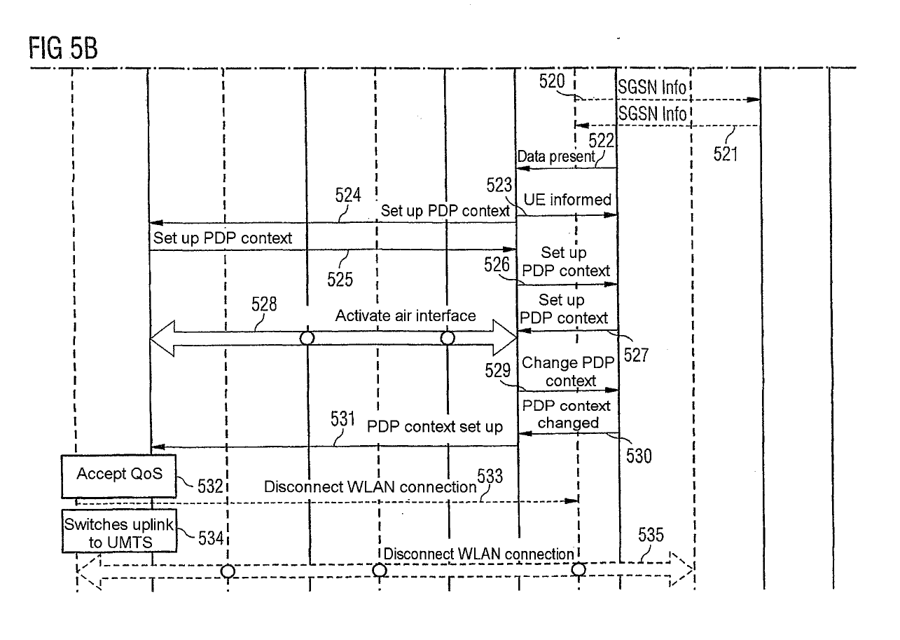

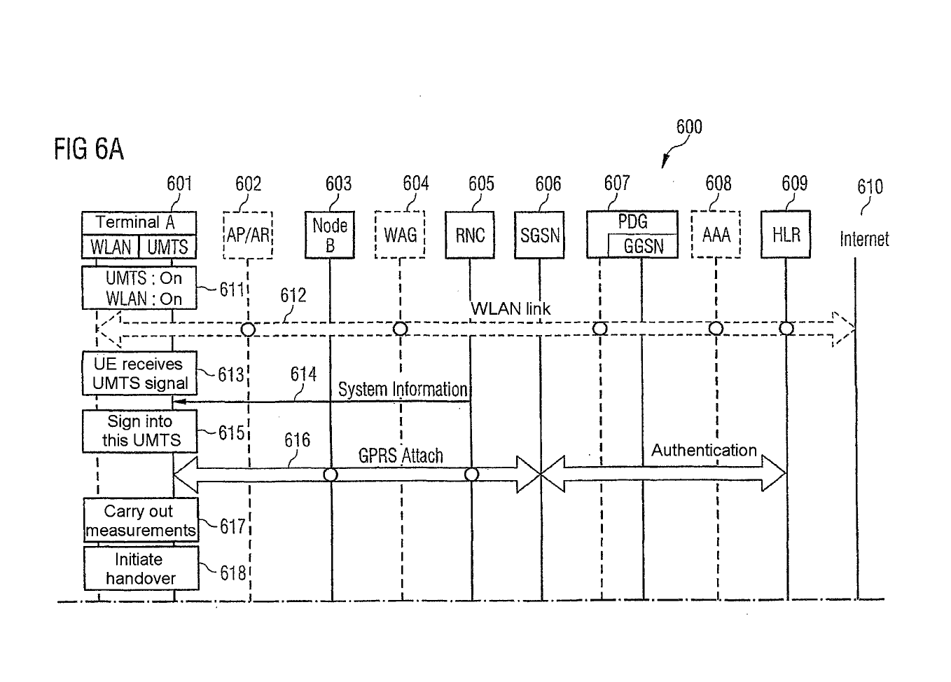

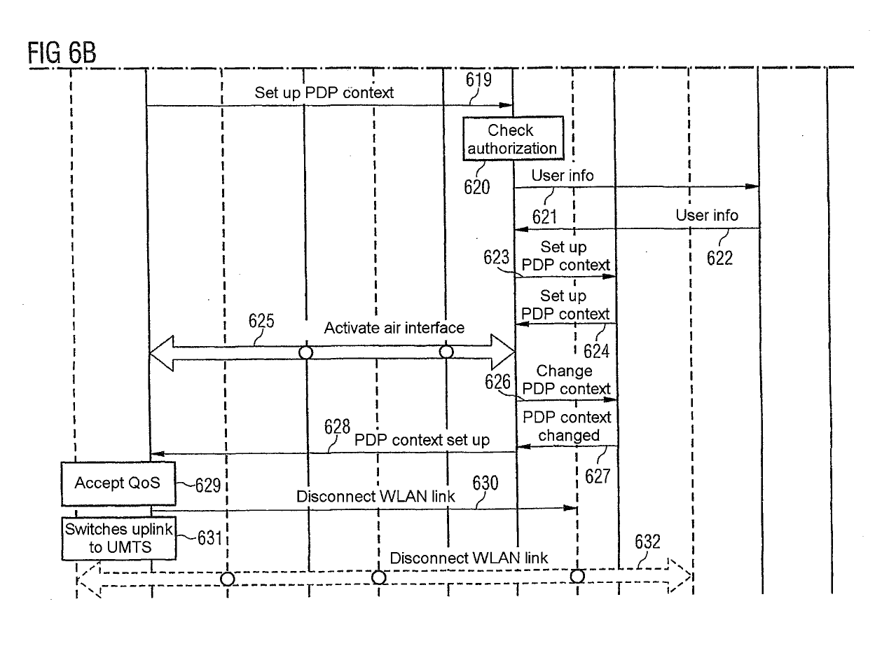

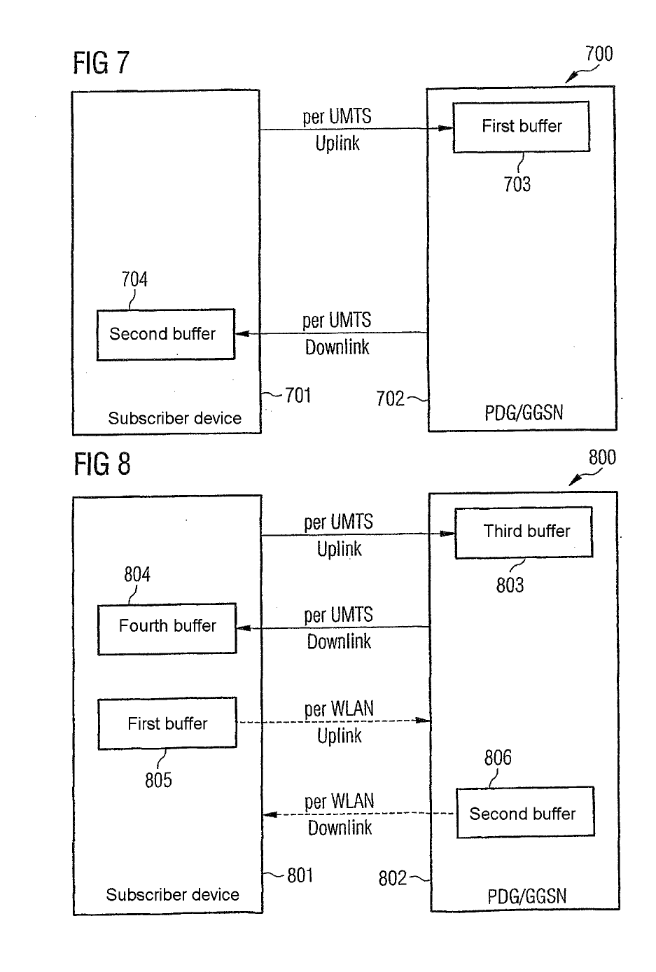

In the text which follows, exemplary embodiments of the invention in which a handover takes place from a WLAN access network to a UMTS communications network are described with reference to FIG. 5, FIG. 6, FIG. 7 and FIG. 8.

FIG. 5 shows a message flowchart 500 according to an exemplary embodiment of the invention.

The illustrated flow of messages takes place between the following network elements: a subscriber device 501, an access router 502, a base station 503, a WAG 504, an RNC 505, an SGSN 506, a PDG/GGSN 507, an AAA server 508, an HLR 509 and the Internet 510.

These network elements are equipped and connected in accordance with the architecture explained with reference to FIG. 4, in particular each of the network elements is part of a WLAN access network, of a UMTS communications network or of a WLAN/3G interworking network.

The PDG/GGSN 507 combines, as explained, the functionality of a GGSN 530 and of a PDG 531 (which are differentiated for the sake of better understanding even though they are both implemented by means of the PDG/GGSN 507).

Actions which are to be carried out are illustrated in FIG. 5 by rectangles. Transmissions of messages are illustrated by an arrow. Double arrows characterize a combination of messages and actions.

Messages, actions and network elements which are part of the WLAN access network or of the WLAN/3G interworking network or which are carried out or transmitted by elements of the WLAN access network or of the WLAN/3G interworking network are represented by dashed lines.

Messages, actions and network elements which are part of the UMTS communications system or are carried out or transmitted by means of elements of the UMTS communications system are represented by unbroken lines.

In step 511, the user of the subscriber device 501 determines which radio technologies are to be activated in his terminal.

It is assumed that the user determines that the UMTS transmitter and the UMTS receiver as well as the WLAN transmitter and the WLAN receiver are to be activated.

In addition, the user determines how the subscriber device 501 behaves in the case of a handover.

The user makes a selection from the following three possibilities:

an inter-system handover is never carried out;

an inter-system handover is arranged manually by the user, in which case the user is informed by his subscriber device if an inter-system handover is possible; and

an inter-system handover is initiated automatically by the subscriber device 501 in which case the user is informed by the subscriber device 501 if an inter-system handover is carried out.

It is assumed in the text which follows that the user selects the possibility 2 or 3 in step 511.

The subscriber device 501 makes available suitable means so that the previously mentioned possibilities can be carried out by the user in order to put the respectively necessary messages into practice and implement the selected possibility.

As mentioned it is assumed that in step 512 an active (communications) link is provided, by means of the WLAN access network to a communications terminal (not shown) which is part of the Internet 510.

In particular, it is assumed that a communications link setup has taken place and that the subscriber device 501 has been authenticated by means of the AAA server 508 and authorized for the existing communications link.

If the subscriber device 501 is located outside the UMTS coverage area, or if the subscriber device 501 is not yet registered in the packet switched area of the UMTS communications system, that is to say a GPRS attach (General Packet Radio Service Attach) has not yet been carried out, the sequence is continued with step 513.

If the subscriber device 501 has already carried out a GPRS attach before the setup of the communications link, the sequence is continued with step 517.

In step 513, the user moves into a UMTS coverage area. This means that the subscriber device 501 receives the pilot channel provided in accordance with the UMTS standard.

In step 514, the subscriber device 501 reads system information transmitted by the RNC 505 by means of the base station 503.

In step 515, the subscriber device 501 determines, by means of the system information, whether the UMTS communications network which has the base station 503 is the home network of the subscriber device 501.

If this is the case, which is assumed in the text which follows, the subscriber device 501 makes the decision to sign into the UMTS communications network.

The signing into the packet switched part of the UMTS communications network is referred to as GPRS attach.

In step 516, the subscriber device 501 initiates the procedure for a GPRS attach and transmits a message with an identifier for the subscriber device 501 to the SGSN 506.

If this identifier is not known to the SGSN 506, the subscriber device 501 is authenticated.

It is also possible that the subscriber device 501 is simultaneously signed into the line switched part of the UMTS communications network.

In step 517 the subscriber device 501 carries out measurements on the air interface of the WLAN and of the UMTS communications network. This is an optional possibility. The subscriber device measures, for example, the reception field strengths of the WLAN and of the UMTS communications network and the data rate of the existing WLAN communications link.

The subscriber device 501 preferably measures the reception field strength and the average data rate of the existing WLAN communications link at regular intervals.

If a predefinable limit is undershot, the sequence is continued with step 518 and a handover is initiated.

The limit is selected such that the transmission of data is still possible by means of the WLAN or shortly after the limit is undershot. Otherwise, the handover could not be initiated.

If the user has selected the second possibility, he is informed in step 518 that an inter-system handover is now possible.

In addition, the quality of the existing WLAN communications link and the possible UMTS communications links, for example the reception field strengths of the WLAN and of the UMTS communications network and the average data rate of the existing WLAN communications link, can be indicated to the user as a decision aid.

If the user agrees to a handover, the sequence is continued with step 519.

If the user has selected the third possibility, the subscriber device 501 automatically carries out the step 519.

If there are a plurality of communications links by means of the WLAN, in step 519 the subscriber device 501 decides which of them are provided for the handover, that is to say which of them are to be carried on by means of the UMTS communications system, and it transmits a message by means of the WLAN transmitter to the PDG/GGSN 507, which message signals that the subscriber device 501 is requesting a handover.

The message contains, inter alia, an identifier of the user from the point of view of the WLAN/3G interworking network, which identifier is referred to below as WLAN-ID, and one or more identifiers of the WLAN communications links which are provided for the handover, that is to say communications links which are provided by means of the WLAN.

The identifier of a WLAN communications link is the W-APN (WLAN Access Point Name) of the WLAN communications link which the user or the subscriber device 501 has selected when setting up the WLAN communications link.

The PDG/GGSN 507 checks whether it has stored the SGSN address of the subscriber device 501, that is to say the address of the SGSN 506, which is assigned to the subscriber device 501, that is to say by means of which the subscriber device 501 can set up communications links to the UMTS communications system.

If this is the case, the sequence is continued with step 522, and otherwise the sequence is continued with step 520.

In step 520, the PDG/GGSN 507 transmits a message to the HLR 509 with which it requests the SGSN address of the subscriber device 501.

This message contains, inter alia, the WLAN ID.

In step 521 the HLR 509 searches for the SGSN address of the subscriber device 501 using the WLAN-ID.

If the HLR 509 does not find the SGSN address, the HLR 509 converts the WLAN-ID into an IMSI (International Mobile Subscriber Identity) and searches for the SGSN address using the IMSI.

In addition, the PDP address for this IMSI is searched for, said PDP address being assigned to the subscriber device 501.

The HLR 509 subsequently transmits the SGSN address, the IMSI, the WLAN-ID and the PDP address of the subscriber device 501 to the PDG/GGSN 507.

The HLR 509 has a table by means of which the IMSI of the subscriber device 501 can be determined using the WLAN-ID.

The steps 522 to 532 are carried out once for each WLAN communications link which is to be carried on by means of a UMTS communications link of the UMTS communications network.

In the text which follows, the term WLAN communications link always refers to one of the WLAN communications links which are to be carried on by means of UMTS, and in the text which follows the term UMTS communications link which is to be set up always refers to the UMTS communications link which serves to carry on the WLAN communications link.

In step 522 the PDG/GGSN 507 determines, by using the type of the WLAN communications link, the suitable PDP (Packet Data Protocol) type for the UMTS communications link which is to be set up. The PDP type of a communications link specifies the protocol to be used for a communications service which is utilized by means of the communications link, for example in the case of the PDP type “IP” the Internet protocol is used.

In addition, a suitable modified APN (Access Point Name), that is to say a designation for the UMTS communications link to be set up, is determined from the W-APN.

This APN is determined in such a way that the SGSN 506 can use the APN to address the PDG/GGSN 507, that the APN can be used to request the same services as those used by means of the WLAN communications links, and that the subscriber device 501 can use the APN to detect which W-APN the APN has been determined from.

The modified APN is also referred to in the text which follows as M-APN.

The PDG/GGSN 507 determines a PDP address which is assigned to the subscriber device 501: either the UMTS-specific PDP address which is received from the HLR 509 or the WLAN address, that is to say the address by means of which the subscriber device 501 can be addressed via the WLAN communications link.

The PDP address is usually an IP address. The WLAN address is preferably used as PDP address. Otherwise it is necessary for the PDG/GGSN 507 to convert the PDP address in each data packet into the WLAN address, or to convert the WLAN address into the PDP address so that the communications link to the communications terminal (not shown) continues to exist in the Internet.

Subsequently, the PDG/GGSN 507 transmits, for the WLAN communications link which is to be carried on by means of the UMTS communications network, a message to the SGSN 506 whose address was contained in the message transmitted by the HLR 509 in step 521 and received by the PDG/GGSN 507.

The transmitted message signals to the SGSN 506 that data packets are present for the subscriber device 501. The transmission of these messages is independent of whether or not data packets are actually being transmitted to the subscriber device 501 by means of the WLAN access network at this moment.

The message contains, inter alia, the values of the following parameters: IMSI, PDP type, PDP address and M-APN. The parameter values are, as has been determined in the preceding processing steps.

In step 523 the SGSN 506 confirms to the PDG/GGSN 507 by means of a confirmation message that the SGSN 506 signals to the subscriber device 501 that data packets are present. The PDG/GGSN 507 subsequently makes available a first buffer for the data packets which will be transmitted in future from the subscriber device 501 to the communications terminal in the Internet by means of the UMTS communications link to be set up.

The data packets are buffered until the PDG/GGSN 507 switches over to the UMTS communications link (see step 535).

As mentioned above, the steps 522 to 532 for each WLAN communications link which is to be carried on by means of a UMTS communications link of the UMTS communications network are carried out once. In particular, a confirmation message is transmitted for each WLAN communications link which is to be carried on by means of the UMTS communications system.

In step 524, the SGSN 506 transmits a message to the subscriber device 501 in order to request the setup of a PDP context.

This message contains values of the following parameters: transaction identifier (TI), which specifies a bidirectional data flow which is carried out, for example, within the scope of a communications service which is used by means of the WLAN communications link, PDP type, PDP address and M-APN.

As mentioned above, the steps 522 to 532 are carried out once for each WLAN communications link which is to be carried on by means of a UMTS communications link of the UMTS communications network. In particular, this message is transmitted once by the SGSN 506 for each WLAN communications link which is to be carried on by means of the UMTS communications system.

In step 525 the subscriber device 501 selects, for the UMTS communications link which is to be set up, the desired bit rate, the maximum delay time and the maximum bit error rate for both directions of the transmission of data within the scope of the UMTS communications link which is to be set up.

In this context, the subscriber device 501 can take into account the equivalent values of the existing WLAN communications links and specific desires of the user.

Subsequently, the subscriber device 501 transmits, for the WLAN communications link which is to be carried on in the UMTS, a message with the request for the setup of a PDP context to the SGSN 506.

This message contains values of the following parameters: TI, NSAPI (Network layer Service Access Point Identifier), which specifies the service access point of the network layer which the PDP context is to use, PDP type, PDP address, M-APN, PDP configuration options which specify further PDP options, and QoS (Quality of Service) requested which specifies the requested communications quality, for example, the bit rates, the maximum delay times and the maximum bit error rates, in each case for both directions of the transmission of data within the scope of the UMTS communications link which is to be set up.

In this context the M-APN which is contained in the message received by the subscriber device 501 in step 524 is selected as the M-APN.

In step 526 the SGSN 506 decides whether the PDP context requested by means of the message received in step 525 is to be set up or not.

For this purpose, the SGSN 506 checks whether the desired QoS parameter values can be made available and whether the user is enabled, that is to say authorized, for these QoS parameter values.

If appropriate, the SGSN 506 corrects, that is to say changes, the values or declines the setup of the PDP context.

The corrected QoS parameters are referred to as QoS negotiated.

Subsequently, the PDG/GGSN 507 is informed by means of a message about the PDP context to be set up by using the M-APN contained in the message received in step 525.

As mentioned above, the steps 522 to 532 for each WLAN communications link which is to be carried on by means of a UMTS communications link of the UMTS communications network are carried out once. In particular, a message with information about the PDP context which is to be set up is transmitted to the PDG/GGSN 507 for each WLAN communications link which is to be carried on by means of the UMTS communications system.

The message contains values of the following parameters: TEID (Tunnel Endpoint Identifier) which specifies an endpoint in the UMTS communications network, PDP-type, PDP address, M-APN, QoS negotiated, NSAPI, MSISDN, that is to say the telephone number, charging characteristics, which specifies the type of charges for the communications link, selection mode, which specifies how the parameter charging characteristics have been selected, trace reference, trace type and trigger Id, which three parameter values are used to generate trace records which indicate which path data takes through the communications system, OMC identity (Identification of the Operation and Maintenance Center) and PDP configuration options.

In step 527 the PDG/GGSN 507 checks whether the desired QoS parameters are compatible with the PDP context to be set up.

If this is the case, it generates a new entry in the PDP context table and determines a new charging ID for the charging system, that is to say, an indicator which is used for calculating charges. It subsequently transmits a message to the SGSN 506 with the parameters PDP address, PDP configuration options, QoS negotiated, charging Id and cause. The value of the parameter cause indicates whether the PDP context which is to be set up has been set up or not. If the PDP context which is to be set up has not been set up the value of the parameter cause indicates the reason why it has not been set up.

Otherwise, the PDP context is not set up.

In step 528 the SGSN 506 corrects, if appropriate, the QoS parameter values and initiates the setup of the air interface by transmitting a message to the RNC 505.

Apart from the SGSN 506, the RNC 505 and the subscriber device 501 are involved in the procedure for setting up the air interface. This procedure is configured as described in 3GPP TSG-SA TS 23.060, General Packet Radio Service (GPRS); Service description; Stage 2 (section: RAB Assignment Procedure).

As mentioned above, the steps 522 to 532 are carried out once for each WLAN communications link which is to be carried on by means of a UMTS communications link of the UMTS communications network. In particular, the procedure for setting up the air interface is carried out for each WLAN communications link which is carried on by means of the UMTS communications system.

In step 529 the QoS parameter values which were possibly corrected in step 528 are communicated to the PDG/GGSN 507 by means of a change report message, after the air interface has been set up.

Since steps 522 to 532 are carried out once for each WLAN communications link which is to be carried on by means of a UMTS communications link of the UMTS communications network, a change report message is transmitted in particular for each WLAN communications link which is carried on by means of the UMTS communications system.

In step 530 the change report is confirmed by the PDG/GGSN 507 to the SGSN 506 by means of a corresponding message.

In step 531 the SGSN 506 adds, for the communications link to be set up, the NSAPI and the GGSN address, that is to say the address of the PDG/GGSN 507, to the PDP context.

After a PDP context has been set up, the setup of the PDP context is confirmed to the subscriber device 501.

In step 532, the subscriber device 501 checks for each confirmation the QoS parameter values which are, as it were, offered to the subscriber device 501.

The checking can be carried out automatically by the subscriber device or the user can be asked whether he agrees with these QoS parameter values.

If the QoS parameter values do not correspond to the predefinable conditions since, for example, the user is not in agreement, the subscriber device 501 transmits a message which triggers the release of the affected PDP context.

In this case, the WLAN communications link is maintained and the sequence is ended for this WLAN communications link.

If the QoS parameter values are accepted, the sequence is continued with step 533.

In step 533 the subscriber device 501 transmits, by means of a WLAN communications link, a message to the PDG/GGSN 507 with which it reports the disconnection of the WLAN communications links which are carried on by means of UMTS communications links.

The message contains the WLAN-ID and the M-APN of all the WLAN communications links which are being carried on by means of the UMTS communications system.

Furthermore, a second buffer is configured for the useful data received from the communications terminal in the Internet by means of the UMTS communications links.

These useful data are buffered until the subscriber device 501 receives the message transmitted in step 535 or until a timer which specifically operates for this measure in the subscriber device 501 since the termination of the step 532 runs out.

After switching over to UMTS has been carried out in step 534, the subscriber device 501 transmits the useful data corresponding to the WLAN communications links to be carried on, in the uplink to the communications terminal on the Internet, now only by means of the UMTS communications links which carry on the WLAN communications links.

In step 535, the PDG/GGSN 507 permits, after the reception of the message transmitted in step 533, the transmission of useful data from the subscriber device 501 of the WLAN communications links to be carried on, now only by means of the UMTS communications links which carry on the WLAN communications links.

Data which have already been received by means of one of the UMTS communications links and which are now located in the first buffer configured in step 523, are passed on to the communications terminal on the Internet in a chronological order.

If all the WLAN communications links are carried on by means of UMTS communications links, the PDG/GGSN 507 transmits, by means of each WLAN communications link, a termination message to all the units involved in the WLAN communications link, vis-à-vis the WAG 504, the access router 502, the AAA server 508, the HLR 509 and the subscriber device 501, by means of which message the disconnection of the WLAN communications link is initiated.

All the data which are transmitted to the subscriber device 501 by the communications terminal on the Internet are now only transmitted to the subscriber device 501 by means of the UMTS communications links.

If at least one WLAN communications link is not to be carried on by means of a UMTS communications link but rather is to continue to be provided by means of the WLAN access network, the WLAN communications link is maintained and a continuation message is transmitted to all the units involved in this WLAN communications link, said continuation message signaling the termination of the continued WLAN communications links but not the release of the WLAN communications link, which continues to be provided.

In addition, in step 535, all the units involved in the WLAN communications link carry out the necessary measures to terminate the respective WLAN communications link after the reception of the termination message.

If a continuation message has been transmitted, the WLAN communications link is not terminated by the involved units.

The subscriber device 501 processes the data which have already been received by means of the UMTS communications link and have been stored, in the chronological order in which said data were received, in the second buffer configured in step 533.

The user is informed by the subscriber device 501 that an inter-system handover has taken place.

If a plurality of WLAN communications links of a subscriber device 501 which are made available by means of different PDG/GGSN are to be handed over, that is to say carried on, the sequence described above is carried out by each affected PDG/GGSN.

The PDG/GGSN can be differentiated by means of the W-APN.

The embodiment explained with reference to FIG. 5 is defined by the fact that, compared with an embodiment which is explained below with reference to FIG. 6, the necessary changes to the UMTS communications network are very small compared to a typical UMTS communications network.

FIG. 6 shows a message flowchart 600 according to an exemplary embodiment of the invention.

In a way analogous to the exemplary embodiment described with reference to FIG. 5, the illustrated message flow takes place between the following network elements: a subscriber device 601, an access router 602, a base station 603, a WAG 604, an RMC 605, an SGSN 606, a PDG/GGSN 607, an AAA server 608, an HLR 609 and the Internet 610.

In a way analogous to the exemplary embodiment described with reference to FIG. 5, these network elements are configured and connected in accordance with the architecture explained with reference to FIG. 4, in particular each of the network elements is part of a WLAN access network, of a UMTS communications network or of a WLAN/3G interworking network.

The PDG/GGSN 607 combines, in an analogous fashion to that above, the functionality of a GGSN 630 and of a PDG 631 (which are differentiated for the sake of better understanding even though they are both implemented by means of the PDG/GGSN 607).

In a way which is analogous to FIG. 5, actions to be carried out are represented by rectangles in FIG. 6. Transmissions of messages are represented by an arrow. Double arrows characterize a combination of messages and actions.

Messages, actions and network elements which are part of the WLAN access network or of the WLAN/3G interworking network or are carried out or transmitted by elements of the WLAN access network or of the WLAN/3G interworking network are represented by dashed lines.

Messages, actions and network elements which are part of the UMTS communications system or are carried out or transmitted by elements of the UMTS communications system are represented by unbroken lines.

The exemplary embodiment described below with reference to FIG. 6 differs from the exemplary embodiment described with reference to FIG. 5 in that the handover is initiated by the subscriber device 501 by transmitting a message by means of the UMTS communications system instead of by means of the WLAN communications system.

A significant advantage of the following exemplary embodiment is that in this procedure a handover is still possible if the WLAN communications link is already disconnected because, for example, the user has left the WLAN coverage area with the subscriber device.

As a result, the WLAN communications link can be used for as long as possible and a handover is possible even if the WLAN communications link is unexpectedly aborted.

The exemplary embodiment described below also differs from the exemplary embodiment described with respect to FIG. 5 in that steps which are analogous to the steps 519 to 524 are not necessary.

The exemplary embodiment described below can be applied if the IP address of the PDG/GGSN 607 by means of which the WLAN communications link to be transferred is made available is known to the subscriber device 601.

The steps 611 to 616 are analogous to the steps 511 to 516 described with respect to FIG. 5.

In step 617 the subscriber device 601 optionally carries out measurements on the air interface of the WLAN communications system and of the UMTS communications system after a GPRS attach has been carried out.

For example, the subscriber device 601 measures the reception field strengths of the WLAN communications system and of the UMTS communications system and the data rate of the existing WLAN communications links.

The subscriber device 601 preferably measures the reception field strength and the average data rate of the WLAN communications links at regular intervals.

If a predefinable limit is undershot, the handover is then initiated with step 618. In contrast to the exemplary embodiment described with reference to FIG. 5, the WLAN communications link is not necessary to set up the UMTS communications link.

If the user has selected the possibility 1 (see step 511 above), in step 618 said user is provided with the message that an inter-system handover is possible.

In addition, the respective quality of the active, that is to say existing, WLAN communications links and of the possible UMTS communications links, for example the reception field strength of the signals of the WLAN access network and of the UMTS communications network and the average data rate of the existing WLAN communications links, can be indicated to the user as decision aids.

If the user agrees to a handover, the sequence is continued with step 619. If the user has selected the possibility 3, the subscriber device 601 automatically carries out the step 619.

After the decision has been made by the subscriber device 601 to initiate a handover, the subscriber device configures, in step 619, a first buffer which, in the event of the existing WLAN communications links being aborted, stores the useful data to be transmitted until UMTS communications links are set up.

Subsequently, if there are a plurality of WLAN communications links, the subscriber device 601 decides for which WLAN communications links a new UMTS communications link is to be set up by means of the UMTS communications network and it selects, for the UMTS communications links to be set up, the respectively desired bit rates, the maximum delay times and the maximum bit error rates for both data transmission directions of the UMTS communications link.

In this context, the subscriber device 601 can take into account the equivalent values of the current WLAN communications links and specific desires of the user.

Subsequently, the subscriber device 601 transmits a message with a request for the setup of a PDP context for use for a communications service to the SGSN 606.

The message contains values of the following parameters: APN, TI, IP address of the currently used PDG/GGSN 607, NSAPI, PDP type, PDP address, PDP configuration options and QoS requested.

The APN which the subscriber device 601 has also selected for the WLAN communications link and which is to be carried on by means of the PDP context to be set up, referred to as the W-APN, is selected. If a plurality of communications links are to be carried on by means of the UMTS communications network, the above message is transmitted once to the SGSN 606 for each WLAN communications link.

In step 620 the SGSN 606 decides for each message transmitted in step 619 whether the PDP context is to be set up or not. To do this, the SGSN 606 checks whether it can make available the desired QoS parameters and whether the user is authorized, that is to say enabled, for these QoS parameters and for the requested communications service which is made available by means of the requested PDP context.

If information which is necessary for this purpose is not known to the SGSN 606, it requests this information from the HLR 609 with step 621.

Otherwise the sequence is continued with step 623.

In step 621, the SGSN 606 requests the missing information about the user of the subscriber device 601 from the HLR 609.

The missing information may be, for example, information about the authorization to use the requested communications service and the requested QoS parameters. If appropriate the missing information is requested for each UMTS communications link which is to be set up.

In step 622 the HLR 609 transmits the requested information to the SGSN 606.

If the necessary information is known to the SGSN 609, in step 623 the SGSN 609 corrects, if appropriate, the QoS parameters or rejects the setup of the PDP context. The corrected QoS parameters are referred to as QoS negotiated. Subsequently, the SGSN 609 uses the IP address transmitted by the subscriber device 601 to inform the PDG/GGSN 607 about the PDP context to be set up, by means of a message transmitted to the PDG/GGSN 607.

The message contains values of the following parameters: PDP type, PDP address, APN, QoS negotiated, NSAPI, MSISDN, selection mode, charging characteristics, trace reference, trace type, trigger Id, OMC identity and PDP configuration options.

Such a message is transmitted to the PDG/GGSN 607 for each UMTS communications link to be set up.

In step 624 the PDG/GGSN 607 checks, for each received message transmitted in step 623, whether the specified QoS parameter values are compatible with the corresponding PDP context to be set up.

If this is the case, the PDG/GGSN 607 generates a new entry in its PDP context table and determines a new charging ID for the charging system. It subsequently transmits a message to the SGSN 606 with values of the parameters PDP address, PDP configuration options, QoS negotiated, charging Id, cause, for each WLAN communications link which is to be carried on by means of the UMTS communications network.

Otherwise, the PDP context is not set up.

If at least one PDP context is set up the PDG/GGSN 607 creates two buffers, a second buffer which, for the event of the corresponding WLAN communications link aborting, stores the useful data to be transmitted to the subscriber device 601 until the corresponding UMTS communications link, that is to say the one which carries on the WLAN communications link, is set up, and a third buffer which stores the data received from the subscriber device 601 via the UMTS communications network, until the WLAN communications link has been terminated.

In step 625 the SGSN 606 corrects, if appropriate, the QoS parameter values and initiates the setup of the air interface by transmitting a message to the RNC 605 for each WLAN communications link which is to be carried on by means of the UMTS communications network.

Apart from the SGSN 606, the RNC 605 and the subscriber device 601 are involved in the procedure for setting up the air interface. This procedure is configured as described in 3GPP TSG-SA TS 23.060, General Packet Radio Service (GPRS); Service description; Stage 2 (section: RAB Assignment Procedure).

This procedure is carried out once for each WLAN communications link which is to be carried on by means of the UMTS communications network.

After the air interface is set up, in step 626 the QoS parameter values which are possibly corrected in step 625 are communicated to the PDG/GGSN 607 by means of a change report message. A change report is transmitted for each WLAN communications link which is to be carried on in the UMTS.

In step 627, the change report is confirmed to the SGSN 606 by the PDG/GGSN 607 by means of a corresponding message.

In step 628, the SGSN 606 adds the NSAPI and the GGSN address, that is to say, the address of the PDG/GGSN 607, to the PDP context for the communications link which is to be set up.

After the setup of a PDP context, the setup of the PDP context is confirmed to the subscriber device 601.

In step 629 the subscriber device 601 checks for each confirmation the QoS parameter values which have, as it were, been offered to the subscriber device 601.

If the QoS parameter values do not correspond to predefinable conditions since, for example, the user is not in agreement, the subscriber device 601 transmits a message which triggers the release of the corresponding PDP context.

In this case, the WLAN communications link continues to be maintained and the sequence is terminated for this WLAN communications link.

If the QoS parameter values are accepted for at least one PDP context, the sequence is continued with step 630.

Otherwise, no handover is carried out and the WLAN communications link is maintained.

If all the communications links which are made available for the subscriber device 601 by means of the WLAN access network are to be carried on by means of the UMTS communications network, in step 630 the subscriber device 601 transmits, by means of a UMTS communications link, a first notification message to the PDG/GGSN 607 with which it provides notification of the disconnection of the WLAN communications links.

The first notification message contains the following parameter values: the WLAN-ID and the M-APN of all the WLAN communications links which are to be carried on by means of the UMTS communications network.

Furthermore, a fourth buffer for the useful data which are received from the communications terminal on the Internet by means of the UMTS communications links is configured.

If at least one WLAN communications link is still to be provided, a second notification message is transmitted to the PDG/GGSN 607, which message reports which PDP contexts have been accepted by the subscriber device 601 and which have been rejected.

After switching over to UMTS has taken place in step 631, the subscriber device 601 transmits the useful data corresponding to the WLAN communications links to be carried on to the communications terminal on the Internet, now only by means of the UMTS communications links which carry on the WLAN communications links.

The user receives from the subscriber device 601 the notification that an inter-system handover has taken place.

In step 632, the PDG/GGSN permits, after the reception of the message transmitted in step 630, the transmission of useful data from the subscriber device 601 of the WLAN communications links to be carried on, now only by means of the UMTS communications links which carry on the WLAN communications links.

Data which have already been transmitted by the subscriber device 601 by means of one of the UMTS communications links and which are now located in the third buffer configured in step 624 are passed on to the communications terminal on the Internet in the chronological order in which they were transmitted by the subscriber device.

If useful data are located in the second buffer for the subscriber device 601, said data are also carried on to the subscriber device 601 in the chronological order in which they were stored in the buffer.

Subsequently, the PDG/GGSN 607 transmits a termination message, by means of a WLAN communications link to be disconnected, to all the units involved in the WLAN communications link, that is to say the WAG 604, the access router 602, the AAA server 608, the HLR 609 and the subscriber device 601, by means of which message the disconnection of the WLAN communications link is initiated.

Data which are transmitted within the scope of a communications service whose transmission of data has been carried out before the disconnection by means of the disconnected WLAN communications link are transmitted to the subscriber device 601, now only by means of the UMTS communications link which carries on the WLAN communications link.

If the PDG/GGSN 607 has received the second notification message, the WLAN communications links which are to be maintained continue to be maintained and a continuation message which signals the termination of the continued WLAN communications links, but does not lead to the release of all the WLAN communications links, is transmitted to all the units involved in the WLAN communications links which continue to be provided.

In addition, in step 632 all the units involved in the continued WLAN communications links carry out the necessary measures for terminating the continued WLAN communications link after the reception of the termination message.

After the disconnection of the WLAN communications link, the subscriber device 601 processes the data which have already been received by means of the UMTS communications link and are now located in the fourth buffer, in the chronological order in which they were received.

If useful data for the communications terminal on the Internet are located in the first buffer, said data are then transmitted to the communications terminal on the Internet in the chronological order in which they were stored in the buffer.

If a continuation message has been transmitted, the WLAN communications link is not terminated by the involved units.

If a plurality of WLAN communications links of a subscriber device 601 which are made available by means of different PDG/GGSN are to be handed over, that is to say carried on, the sequence described above is carried out by each affected PDG/GGSN.

The PDG/GGSN can be differentiated by means of the W-APN.

For the sake of better understanding, the arrangement of the buffers used in the exemplary embodiment described with reference to FIG. 5 and the arrangement of the buffers used in the exemplary embodiment described with reference to FIG. 6 will be explained below.

FIG. 7 shows an arrangement of buffers 700 according to an exemplary embodiment of the invention.

The buffers are arranged in a subscriber device 701 which corresponds to the subscriber device 501 and in a PDG/GGSN 702 which corresponds to the PDG/GGSN 507.

In the PDG/GGSN 702, a first buffer 703, which corresponds to the first buffer mentioned in the explanation of FIG. 5, is arranged.

In the subscriber device 701, a second buffer 704, which corresponds to the second buffer mentioned in the explanation of FIG. 5, is arranged.

As explained above with reference to FIG. 5, the first buffer 703 stores the data which are to be transmitted to the communications terminal on the Internet by the subscriber device 701 by means of a UMTS communications link which has already been set up.

These data are not passed on until the corresponding WLAN communications link, that is to say the WLAN communications link which carries on the UMTS communications link, has been released.

This permits the simultaneous existence of the UMTS communications link and of the WLAN communications link.

Since the uplink data stream is, as it were, not let through by the PDG/GGSN 702 by means of the UMTS communications link but is instead buffered, it is not necessary for the PDG/GGSN 702 to pass on two data streams to the Internet simultaneously and this would require double the number of network layer entities.

The first buffer is therefore, as it were, located below the network layer in this exemplary embodiment of the Internet protocol layer.

The second buffer 704 has the function analogous with the first buffer. As explained above with reference to FIG. 5, the second buffer 704 stores the data received by the subscriber device 701 by means of the UMTS communications link which has already been set up.

These data are not processed until the corresponding WLAN communications link, that is to say the WLAN communications link which continues the UMTS communications link, is released.

In a way which is analogous to the first buffer 703, this is permitted by the parallel existence of the UMTS communications link and of the WLAN communications link.

The first buffer 703 and the second buffer 704 can be considered as reception buffers since the first buffer 703 stores data which have been received by the PDG/GGSN 704, and the second buffer 704 stores data which have been received by the subscriber device 701.

FIG. 8 shows an arrangement of buffers 800 according to an exemplary embodiment of the invention.

The buffers are arranged in a subscriber device 801 which corresponds to the subscriber device 601 and in a PDG/GGSN 802 which corresponds to the PDG/GGSN 607.

A third buffer 803, which corresponds to the third buffer mentioned in the explanation of FIG. 6, and a second buffer 803, which corresponds to the second buffer mentioned in the explanation of FIG. 6, are arranged in the PDG/GGSN 802.

A fourth buffer 804, which corresponds to the fourth buffer mentioned in the explanation of FIG. 6, and a first buffer 805, which corresponds to the first buffer mentioned in the explanation of FIG. 6, are arranged in the subscriber device 801.

The third buffer 803 has a functionality which is analogous to the first buffer 703 explained with respect to FIG. 7.

The fourth buffer 804 has a functionality which is analogous to the second buffer 704 which is explained with respect to FIG. 7.

The third buffer 803 and the fourth buffer 804 are therefore not explained in more detail below.

As is explained above with reference to FIG. 6, the first buffer 805 stores the data which are to be transmitted in the uplink from the subscriber device 801 by means of a WLAN communications link which has already been released. These data are, as explained, transmitted with the corresponding UMTS communications link if it is set up.

As is explained above, with respect to FIG. 6, the second buffer 806 stores the data which are to be transmitted in the downlink to the subscriber device 801 by means of a WLAN communications link which has already been released. These data are, as explained, transmitted with the corresponding UMTS communications link if it is set up.

The first buffer 805 and the second buffer 806, as it were, permit the WLAN communications links which are to be released to be used for as long as possible and no data are lost even in the event of a sudden abort of the WLAN communications links which occurs, for example, due to the user of the subscriber device 801 leaving a WLAN radio cell.

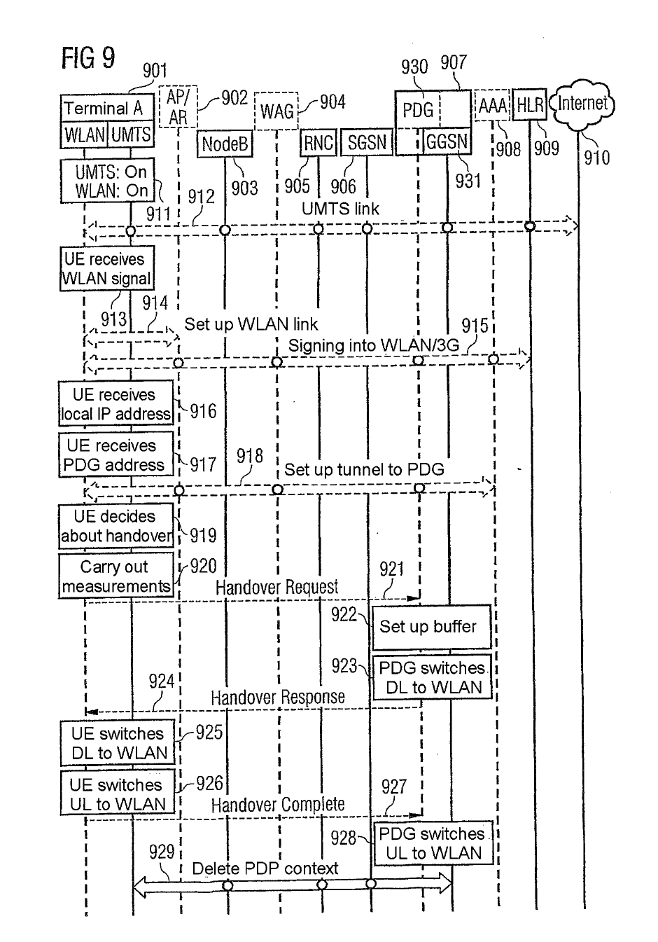

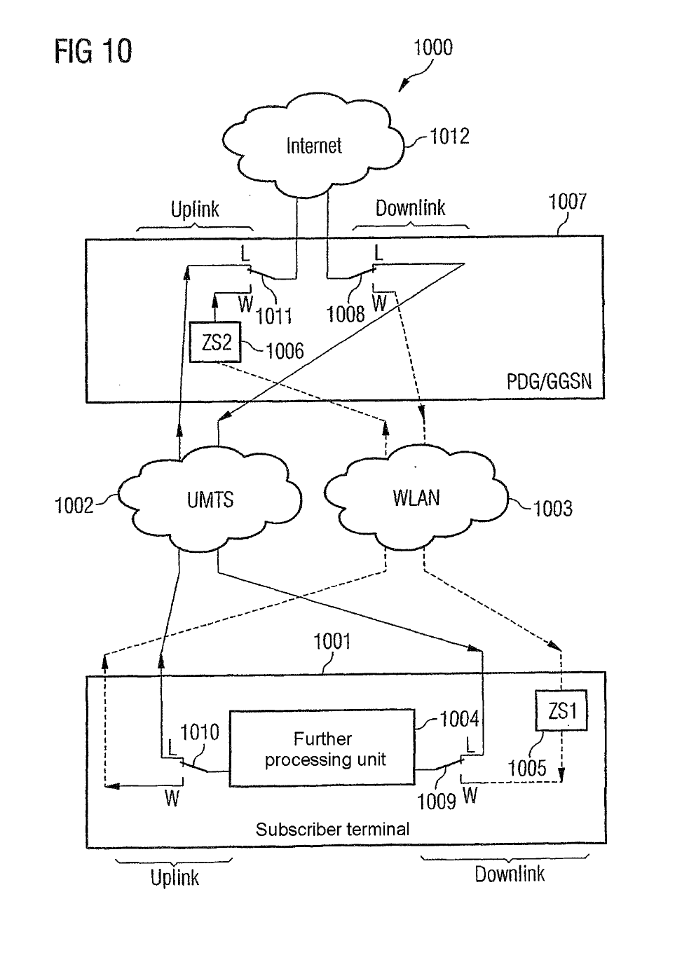

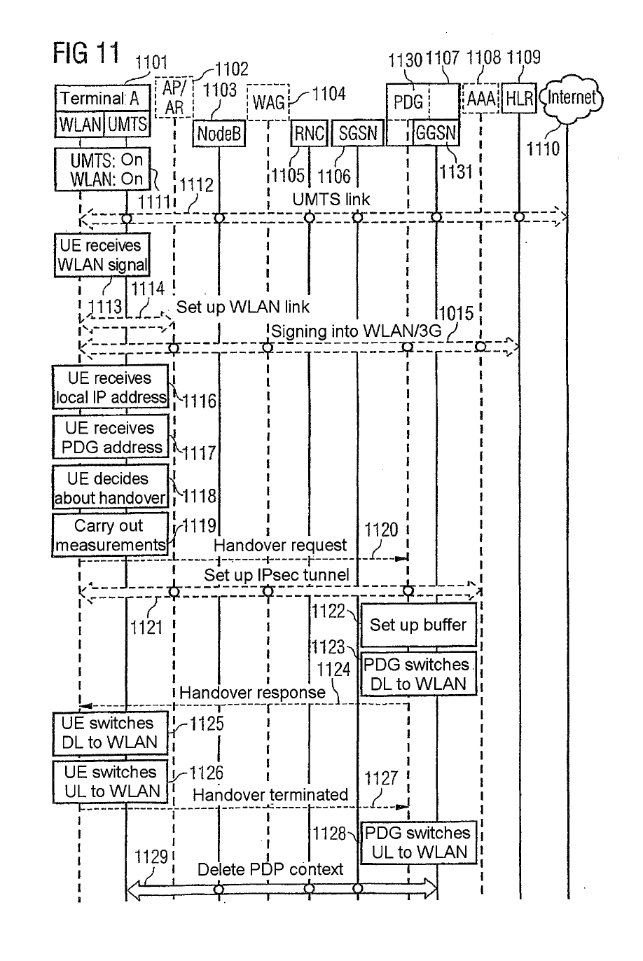

In the text which follows, exemplary embodiments of the invention in which a handover occurs from a UMTS communications network to a WLAN access network are described with reference to FIG. 9, FIG. 10 and FIG. 11.

FIG. 9 shows a message flowchart 900 according to an exemplary embodiment of the invention.

The illustrated message flow takes place between the following network elements: a subscriber device 901, an access router 902 (and an access point connected thereto), a base station 903, a WAG 904, an RNC 905, an SGSN 906, a PDG/GGSN 907, an AAA server 908, an HLR 909 and the Internet 910.

These network elements are embodied and connected in accordance with the architecture explained with respect to FIG. 4, in particular each of the network elements is part of a WLAN access network, of a UMTS communications network, also referred to below generally as PLMN (Public Land Mobile Network), or of a WLAN/3G interworking network.

Actions which are to be carried out are represented in FIG. 9 by rectangles. Transmissions of messages are represented by an arrow. Double arrows characterize a combination of messages and actions.

Messages, actions and network elements which are part of the WLAN access network or of the WLAN/3G interworking network, or are carried out or transmitted by elements of the WLAN access network or of the WLAN/3G interworking network are represented by dashed lines.

Messages, actions and network elements which are part of the UMTS communications system or are carried out or transmitted by means of elements of the UMTS communications system are represented by unbroken lines.

In step 911 the user of the subscriber device 901 determines which radio technologies are to be activated in his terminal.

It is assumed that the user determines that the UMTS transmitter and the UMTS receiver as well as the WLAN transmitter and the WLAN receiver of the subscriber device 901 are to be activated.

In addition, the user sets the subscriber device 901 to carry out an automatic handover on the packet switched communications link provided by means of the UMTS communications network, as soon as a WLAN (access network) which is suitable for this purpose is available. In other developments of the invention, rules are provided in which a handover is initiated if appropriate.

As mentioned, it is assumed that in step 912 (at least) one active (communications) link is provided by means of the UMTS communications network t0 a communications terminal (not shown) which is part of the Internet 910.

In particular it is assumed that a communications link setup has taken place and that the subscriber device 901 has been authenticated by means of the AAA server 908 and authorized for the existing communications link.

According to the communications link, there is a PDP (packet data protocol) context between the subscriber device 901 and the GGSN 931. When the communications links are set up the user of the subscriber device 901 has specified an APN (Access Point Name) and thus specifies the communications service which is made available by means of the communications link. The GGSN 931 was selected by the PLMN by means of the APN.

It is assumed that the user moves with the subscriber device 901 into the coverage area of a WLAN radio cell of the WLAN access network in step 913. This is detected by the subscriber device 901 by means of one or both of the following methods:

The subscriber device 901 checks at regular intervals the reception levels at frequencies which are typical of WLAN, that is to say frequencies typically used for the transmission of radio within the scope of WLANs. If the reception level for a frequency which is typical of WLAN exceeds a limiting value the subscriber device 901 is located in the reception area of a WLAN communications network, and the subscriber device 901 detects this.

The PLMN transmits a message to the subscriber device 901, which specifies that a (suitable) WLAN communications network is available. The message has the information indicating the frequency at which the WLAN communications network transmits or receives and/or the SS/D (Service Set Identifier) which the WLAN communications network uses (and in particular transmits).

The subscriber device 901 also determines an access point of the WLAN communications network. It is assumed below that this access point is connected to the access router 902 (the access router 902 is, as it were, responsible for the access point).

In step 914 the subscriber device 901 is associated with the access point, i.e. it sets up a communications link to the WLAN communications network by means of the access point and the access router 902.

In step 915 the subscriber device 901 starts to sign into the home PLMN (HPLMN), i.e. the PLMN with whose operator the user of the subscriber device 901 has a contract, by means of the access point and the access router 902. For this purpose the subscriber device 901 transmits a message with a sign-in request to the access router 902 and an indication of the communications network to which this sign-in request is to be passed on.

For example, the subscriber device 901 can specify a different PLMN from the home PLMN if, for specific reasons, a communications link is to be set up to a PLMN other than the HPLMN.

If the subscriber device 901 specifies the HPLMN in the sign-in request, the access router 902 correspondingly passes on the sign-in request to the AAA server of the HPLMN. If the HPLMN is unknown to the access router 902, the access router transmits a message to the subscriber device 901 which contains a list with all the PLMNs which can be accessed from the access router 902.

It is assumed that in the sign-in request the subscriber device 901 has specified the UMTS communications network with the network components shown. Accordingly, the access router 902 passes on the sign-in request to the AAA proxy (not shown) of the UMTS communications network.

The sequence of signing in is configured, for example, as described in 3GPP TS 24.234 TSG-CN; 3GPP System to WLAN Interworking; UE to Network Protocols (Section 10.2 “WLAN Access Authentication and Authorization”). In this example, it is assumed that the UMTS communications network is the HPLMN of the subscriber device 901 and that the signing in is concluded successfully and the subscriber device 901 is thus signed in in its home PLMN, the UMTS communications network, after step 915.

In the text which follows, the communications links from the subscriber device 901 to the UMTS communications network which are provided (intended) for a handover, that is to say are to be possibly carried on by means of the WLAN access network, are referred to as communications links which are provided for a handover. Accordingly, the PDP contexts which exist in the scope of the communications links which are provided for a handover are referred to as PDP contexts which are provided for a handover. Whether the communications links which are provided for a handover are actually carried on by means of the WLAN access network is not decided until a later sequence step. If method steps which relate to a communications link which are provided for a handover are carried out below, it is always assumed, without stating so, that analogous method steps are carried out for all the other communications links provided for a handover.

After the successful signing in of the subscriber device 901 in the UMTS communications network, a local IP (Internet protocol) address is assigned to the subscriber device 901 by the DHCP (Dynamic Host Configuration Protocol) server (not shown) of the WLAN communications network and is reported by means of a corresponding message. The subscriber device 901 can be accessed (addressed) within the WLAN access network by means of this IP address.

In step 917 the subscriber device 901 initiates a DNS (Domain Name Service) procedure, by transmitting a message, which contains a W-APN (WLAN Access Point Name), to the DNS server (not shown) of the UMTS communications network. The W-APN is configured in such a way that the DNS server can unambiguously determine the PDG which is part of the same PDG/GGSN as the GGSN 931 which is assigned to the PDP context intended for the handover. In this case, this is the PDG 930. In response, the IP address of the PDG 930 is communicated to the subscriber device 901.

Furthermore, during the DNS procedure the AAA server 908 and the AAA proxy which were involved in the signing in of the subscriber device 901 exchange messages with one another and with the WAG 904 and the PDG 930 so that the WAG 904 is informed that the PDG 930 is involved in the planned handover and it is communicated to the PDG 930 that the WAG 904 is involved in the planned handover. In particular, the WAG 904 receives the address of the PDG 930 and passes on to the PDG 930 all the data which are transmitted by the subscriber device 901 in the scope of the communications link, provided for a handover, from the subscriber device 901. The PDG 930 is informed by means of the address of the WAG 904, accepts the data passed on by the WAG and is informed by this means that the subscriber device 901 can be accessed by means of the WAG 904.

In step 918 the subscriber device 901 sets up a reliable IPsec tunnel to the PDG 930 for each PDP context provided for a handover. In this context, the information which is necessary for the encryption of the data transmitted within the scope of the IPsec tunnel is exchanged between the subscriber device 901 and the PDG 930. In particular, a W-APN is transmitted from the subscriber device 901 to the PDG 930 for each IPsec tunnel which is set up. For each IPsec tunnel, the PDG 930 confirms the successful setup of the IPsec tunnel to the subscriber device 901 by means of a corresponding message and also communicates the remote IP address of the subscriber device 901 to the subscriber device 901. By means of the remote IP address, the subscriber device 901 can be accessed from the UMTS communications network. The remote IP address of the subscriber device 901 is communicated to the subscriber device 901 in at least one confirmation about the successful setup of an IPsec tunnel. The confirmation for a successful setup of an IPsec tunnel can have further information about the IPsec tunnel, for example, the expected average data rate and the expected delay times within the scope of the IPsec tunnel. The UMTS communications network can, if appropriate, reject the setup of an IPsec tunnel and thus the handover of the corresponding PDP context or of the corresponding communications link (i.e. the communications link in the scope of which the PDP context is provided) in this step.

In step 919 the subscriber device 901 decides for which communications links which are provided by means of the UMTS communications network a handover is actually to be carried out, and thus which communications links which are provided for a handover and which PDP contexts which are provided for a handover are actually to be passed on by means of the WLAN access network.

The connection costs, the average data rates which can be expected for the set-up IPsec tunnels and delay times can be taken into account in the decision. In addition it is possible to take into account whether the WLAN access network is suitable for passing on the respective communications link. If it is decided that a UMTS communications link is passed on by means of the WLAN access network, the user of the subscriber device 901 is informed that an automatic handover is now carried out. In this context, for example, properties of the WLAN communications link which carry on the UMTS communications link, for example, the data rate or the connection charges, are indicated to the user. Depending on the user settings, the following step 920 is carried out with or without confirmation by the user, i.e. manually or automatically.

In the text which follows, the communications links from the subscriber device 901 to the UMTS communications network which are provided for a handover, and which are actually to be carried on, that is to say are to be actually carried on by means of the WLAN access network in accordance with the decision of the subscriber device 901, are referred to as communications links which are to be carried on. Correspondingly, the PDP contexts which exist within the scope of the communications links which are to be continued are referred to as PDP contexts which are to be continued.

It is assumed below that at least one communications link is to be carried on. In a way which is analogous to the above, if method steps which relate to a communications link which is to be carried on are carried out, it is always assumed in the text which follows, without stating so, that analogous method steps are carried out for all the other communications links which are to be carried on.

In step 920 the subscriber device 901 determines the time for the handover of the communications link which is to be carried on. To do this, the subscriber device 901 determines in each case the reception field strength of the UMTS communications network and of the WLAN access network over a certain time period (possibly repeatedly) and/or determines the respective cell load, i.e. the intensity of use of the UMTS radio cell in whose coverage area the subscriber device 901 is located and by means of which the communications link which is to be carried on is provided, or the WLAN radio cell into which the subscriber device 901 has moved. If the values which are identified exceed or undershoot predefined limiting values, the sequence is continued with step 921.

In step 921 the subscriber device 901 initiates the handover for the communications links which are to be carried on, in that it transmits a message to the PDG 930 by means of the WLAN access network, said message containing the following:

a PDP context identifier, i.e. a designation of the communications link to be carried on, which is used in the scope of the UMTS communications network, for each communications link which is to be carried on, and a specification that a handover is desired.

In addition to FIG. 9, reference is made below to FIG. 10.

FIG. 10 shows a communications system 1000 according to on exemplary embodiment of the invention.

The communications system 1000 has a subscriber device 1001 which corresponds to the subscriber device 901, a UMTS communications network 1002, which corresponds to the aforementioned UMTS communications network which is involved in the handover, a WLAN access network 1003, which corresponds to the aforesaid WLAN access network which is involved in the handover, a PDG/GGSN 1007, which corresponds to the PDG/GGSN 907, and the Internet 1012 (corresponding to the internet 910).

The subscriber device 1001 has a further processing unit 1004 which is configured to process data received from the subscriber terminal 1001 and make available data which are sent by the subscriber device 1001.

The subscriber device 901 sets up a first buffer 1005 (additionally in step 921) which stores the communications data (useful data) transmitted from now on to the subscriber device 1001 from the PDG 930 (or the PDG/GGSN 1007) by means of the WLAN access network 1003. In particular, these communications data are not passed on to the further processing unit 1004 or to an application which is carried out by means of the further processing unit 1004 and which waits for the communications data.

If it is decided no PDP context or no communications link is to be passed on by means of the WLAN access network 1003, step 921 is not carried out but rather a message is transmitted from the subscriber device 901 to the PDG 930, said message signaling the abort of the handover. Finally the sequence is terminated.

In step 922 the PDG 930 prepares, after reception of the message transmitted by the subscriber device 901 in step 921, for the reception of the useful data, transmitted by the subscriber device 901 by means of the WLAN access network 1003, and sets up in particular a second buffer 1006. The second buffer 1006 is provided for all the communications links which are to be carried on. All the useful data which are transmitted from now on to the PDG/GGSN 1007 from the subscriber device 901 by means of the WLAN access network are stored from now on in the second buffer 1006 and firstly not passed on to the receiver provided for the useful data.

In step 923, the PDG/GGSN 1007 makes a setting such that all the useful data to be transmitted to the subscriber device 901 within the scope of the communications links which are to be carried on are now no longer to be transmitted to the subscriber device 901 by means of the UMTS communications network 1002, but rather by means of the WLAN access network 1003. This is illustrated in FIG. 10 by means of a first switch 1008 which is switched over into the position W (for WLAN) from the position U (for UMTS) for the communications links which are to be carried on from the PDG/GGSN 1007. From now on, transmission is, as it were, carried out now only by means of the WLAN access network 1003 in the downlink within the scope of the communications links which are to be carried on. If one or more communications links IPsec tunnel which are provided for the handover and are not to be carried on have been set up (according to the decision of the subscriber device 901 in step 919), these communications links are carried on by means of the UMTS communications network 1002, and the first switch 1008 for these communications links is, as it were, not switched over.

If none of the communications links provided for the handover are to be carried on, the handover is aborted. IPsec tunnels which were set up for the communications links provided for the handover and which are not carried on are released.

In step 924 the PDG/GGSN 1007 for each carried-on communications link, i.e. for each communications link which is to be carried on and for which the PDG/GGSN 1007 has switched over the first switch 1008, informs the subscriber device 901 about the status of the corresponding IPsec tunnel (in particular whether or not the IPsec tunnel has been set up).

In step 925, after reception of the message, transmitted in step 924, for each communications link to be carried on, the subscriber device 901 makes a setting such that the data transmitted to the communications terminal 901 within the scope of the communications links to be carried on are no longer received by means of the UMTS communications network 1002 but rather by means of the WLAN access network 1003. This is illustrated in FIG. 10 by a second switch 1009 which is assigned to the downlink and is switched over into the position W from the position U for the communications links which are to be carried on.

If a useful data packet is received by means of the UMTS communications network 1002, in the scope of a communications link to be carried on, directly before the corresponding switching process, the switching process is not carried out until after this useful data packet has been entirely received.

The useful data which are stored in the first buffer 1005 are then processed in chronological order, i.e. for example, passed on to the application which is waiting for these useful data.

In step 926 the subscriber device 901 for the PDP context which is to be continued switches a third switch 1010 which is assigned to the uplink, from the position U into the position W so that all the useful data sent by the subscriber device 901 within the scope of the corresponding communications link which is to be carried on are no longer transmitted to the PDG/GGSN 1007 by means of the UMTS communications network 1002 but rather by means of the WLAN access network 1003.

In step 927, directly after the switching over of the third switch 1010 for a communications link to be carried on the subscriber device 901 informs the PDG/GGSH 1007 about this switching process.

In step 928, after the reception of the message transmitted by subscriber device 901 in step 927 the PDG/GGSN 1007, as it were, switches over a fourth switch 1011 which is assigned to the uplink, from the position U into the position W for the corresponding communications link which is to be carried on. That is to say, the PDG/GGSN 1007 then no longer receives the useful data sent from the subscriber device in the uplink within the scope of the communications link which is to be carried on by means of the UMTS communications network 1002 but rather by means of the WLAN access network 1003. If a useful data packet is received by the PDG/GGSN 1007 directly before the switching process by means of the UMTS communications network 1002 within the scope of the corresponding PDP context which is to be carried on, the switching process is not carried out until after the reception of this useful data packet.

The useful data which are stored in the second buffer 1006 are then passed on in chronological order to the respective receiver.

In step 929 the GGSN 931 deletes all the UMTS communications links which are no longer used, that is to say it terminates all the communications links of the UMTS communications network 1002 which are carried on by means of the WLAN access network 1003. To do this, the GGSN 931 carries out a “PDP context deactivation procedure” as described in 3GPP TSG-SA TS 23.060, General Packet Radio Service (GPRS); Service description; Stage 2 (Section 9.2.4.). Within the scope of this procedure, messages are exchanged between the GGSN 931, the SGSN 906 and the subscriber device 901.

FIG. 11 shows a message flowchart 1100 according to an exemplary embodiment of the invention.

In a way analogous with the exemplary embodiment described with respect to FIG. 9, the message flow which is illustrated takes place between the following network elements: a subscriber device 1101, an access router 1102 (and an access point connected thereto), a base station 1103, a WAG 1104, an RNC 1105, an SGSN 1106, a PDG/GGSN 1107, an AAA server 1108, an HLR 1109 and the Internet 1110.

In a way which is analogous to the exemplary embodiment described with respect to FIG. 9, these network elements are configured and connected in accordance with the architecture explained with reference to FIG. 4, in particular each of the network elements is part of a WLAN access network, of a UMTS communications network or of a WLAN/3G interworking network.

In a way which is analogous to FIG. 9 actions which are to be carried out are represented by rectangles in FIG. 11. Transmissions of messages are represented by an arrow. Double arrows characterize a combination of messages and actions.

Messages, actions and network elements which are part of the WLAN access network or of the WLAN/3G interworking network, or are carried out or transmitted by elements of the WLAN access network or of the WLAN/3G interworking network, are represented by dashed lines.

Messages, actions and network elements which are part of the UMTS communications system, or are carried out or transmitted by means of elements of the UMTS communications system, are represented by unbroken lines.

The processing steps 1111 to 1117 are carried out in a way analogous to the processing steps 911 to 917 which are described with respect to FIG. 9.

In step 1118, the subscriber device 1101 decides which of the communications links provided by means of the UMTS communications network a handover is actually to be carried out for, and thus which communications links which are provided for a handover and which PDP contexts which are provided for a handover are actually to be carried on by means of the WLAN access network.

The connection costs, the average data rates which can be expected for the set-up IPsec tunnels and delay times can be taken into account in the decision. In addition it is possible to take into account whether the WLAN access network is suitable for carrying on the respective communications link. If it is decided that a UMTS communications link is carried on by means of the WLAN access network, the user of the subscriber device 1101 is informed that an automatic handover is then carried out. In the process, for example, properties of the WLAN communications link which carries on the UMTS communications link, for example, the data rate or the connection charges, are indicated to the user. Depending on user settings, the following step 1119 is carried out with or without confirmation by the user, i.e. manually or automatically.

In the text which follows, as above, the communications links which are provided for a handover from the subscriber terminal 1101 to the UMTS communications network and which are actually to be carried on, that is to say are actually to be carried on by means of the WLAN access network in accordance with the decision of the subscriber device 1101, are referred to as communications links which are to be carried on. Accordingly, the PDP contexts which are provided within the scope of the communications links which are to be carried on are referred to as PDP contexts which are to be carried on.

It is assumed below that at least one communications link is to be carried on. Analogously to the above, if in the text which follows method steps are carried out which relate to a communications link which is to be carried on, it is always assumed, without stating so, that analogous method steps are carried out for all the other communications links which are to be carried on.

In step 1119, the subscriber device 1101 determines the time for the handover of the communications link which is to be carried on. To do this, the subscriber device 1101 in each case determines the reception field strength of the UMTS communications network and of the WLAN access network over a certain time period (possibly repeatedly) and/or determines the respective cell load, i.e. the intensity of use of the UMTS radio cell in whose coverage area the subscriber device 1101 is located and by means of which the communications link which is to be carried on is provided, or the WLAN radio cell into which the subscriber device 1101 has moved. If predefined limiting values exceed or undershoot the identified values, the sequence is continued with step 1120.

In step 1120 the subscriber device 1101 initiates the handover for the communications links to be carried on in that it transmits the message to the PDG 1130 by means of the WLAN access network, said message containing the following:
a PDP context identifier for each communications link to be carried on, i.e. a designation of the communications link to be carried on which is used within the scope of the UMTS communications network;

a specification that a handover is desired;
in each case the W-APN of the communications links which are to be carried on; and
all the information necessary for a setup of a secure IPsec tunnel between the subscriber device 1101 and the PDG 1130.

In addition to FIG. 11 reference is made below to FIG. 10.

The subscriber device 1001 corresponds now to the subscriber device 1101, the UMTS communications network 1002 corresponds to the aforesaid UMTS communications network which is involved in the handover, the WLAN access network 1003 corresponds to the aforesaid WLAN access network which is involved in the handover and the PDG/GGSN 1007 corresponds to the PDG/GGSN 1107.

The subscriber device 1101 sets up (additionally in step 1120) a first buffer 1005 which stores the communications data (useful data) transmitted from now on from the PDG 1130 (or the PDG/GGSN 1007) to the subscriber device 1001 by means of the WLAN access network 1003. In particular, these communications data are not passed on to the further processing unit 1004 or to an application which is carried out by means of the further processing unit 1004 and which waits for the communications data.

If it is decided that no PDP context or no communications link is to be carried on by means of the WLAN access network 1003, step 1120 is not carried out but instead a message is transmitted from the subscriber device 1101 to the PDG 1130, which signals the abort of the handover. The sequence is then terminated.

In step 1121, the communications system, that is to say in this case the PDG 1130, has the possibility of rejecting the setup of an IPsec tunnel and the handover of the PDP context which is to be carried on, for which the IPsec tunnel is set up. In the text which follows, the communications links which are to be carried on and correspondingly the PDP contexts which are to be carried on are understood to be those communications links or PDP contexts which are to be carried on and for which the setup of the corresponding IPsec tunnel is not rejected.

For each PDP context to be carried on, all the necessary measures are taken in order to set up an IPsec tunnel between the PDG 1130 and the terminal 1101 for the PDP context. If it is decided that one or more PDP contexts are not to be carried on, the corresponding communications links are carried on by means of the UMTS communications network 1002.

If no PDP context is to be carried on by means of the WLAN access network 1003, the handover is aborted and the sequence terminated.

For each IPsec tunnel which is set up the PDG 1130 confirms the successful setup of the IPsec tunnel to the subscriber device 1101 by means of a corresponding message, and it also communicates the remote IP address of the subscriber device 1101 to the subscriber device 1101. By means of the remote IP address, the subscriber device 1101 can be accessed from the UMTS communications network. The remote IP address of the subscriber device 1101 is communicated to the subscriber device 1101 in at least one confirmation about the successful setup of an IPsec tunnel. The confirmation of a successful setup of an IPsec tunnel can have further information about the IPsec tunnel, for example, the expected average data rate and the expected delay times within the scope of the IPsec tunnel.

In step 1122, after the setup of the IPsec tunnel the PDG 1130 is prepared for the reception of useful data from the subscriber device 1101 by means of the WLAN access network 1003.

In addition, the PDG 1130 keeps a second buffer 1006 ready. The second buffer 1006 is provided for all the communications links to be carried on. All the useful data which are transmitted from then on from the subscriber device 1001 to the PDG/GGSN 1007 by means of the WLAN access network are stored from then on in the second buffer 1006 and at first not passed on to the receiver which is provided for the useful data.

In step 1123 the PDG/GGSN 1007 makes a setting such that all the useful data to be transmitted to the subscriber device 1101 within the scope of the communications links to be carried on are now no longer transmitted to the subscriber device 1101 by means of the UMTS communications network 1002 but rather by means of the WLAN access network 1003. This is illustrated in FIG. 10 by a first switch 1008 which is switched over from the position U (for UMTS) into the position W (for WLAN) via the PDG/GGSN 1007 for the communications links which are to be carried on. From now on, transmission is, as it were, carried out in the downlink only by means of the WLAN access network 1003 within the scope of the communications links to be carried on.

In step 1124, the PDG/GGSN 1007 informs the subscriber device 1101 about the corresponding switching process for each continued communications link, i.e. for each communications link which is to be carried on and for which the PDG/GGSN 1007 has switched over the first switch 1008.

In step 1125, after reception of the message transmitted in step 1124, the subscriber device 1101 makes a setting for each communications link to be carried on such that the data transmitted to the communications terminal 1101 within the scope of the communications links to be carried on are no longer received by means of the UMTS communications network 1002 but rather by means of the WLAN access network 1003. This is illustrated in FIG. 10 by a second switch 1009 assigned to the downlink and which is switched over from the position U into the position W for the communications links which are to be carried on.

If, within the scope of a communications link which is to be carried on, a useful data packet is received directly before the corresponding switching process by means of the UMTS communications network 1002, the switching process is not carried out until after this useful data packet has been entirely received.

The useful data which are stored in the first buffer 1005 are then processed in chronological order, i.e. for example, passed on to the application which waits for these useful data.

In step 1126 for each PDP context which is to be carried on the subscriber device 1101 switches a third switch 1010, which is assigned to the uplink, from the position U into the position W so that all the useful data which are transmitted by the subscriber device 1101 within the scope of the corresponding communications links which are to be carried on are no longer transmitted to the PDG/GGSN 1007 by means of the UMTS communications network 1002 but rather by means of the WLAN access network 1003.

In step 1127, directly after the third switch 1010 has been switched for a communications link which is to be carried on, the subscriber device 1101 informs the PDG/GGSN 1007 about this switching process.

In step 1128, after reception of the message transmitted by subscriber device 1101 in step 1127, the PDG/GGSN 1007, as it were, switches a fourth switch 1011, which is assigned to the uplink, from the position U into the position W for the corresponding communications link which is to be carried on. That is to say, the PDG/GGSN 1007 then no longer receives the useful data transmitted in the uplink by the subscriber device within the scope of the communications link which is to be carried on by means of the UMTS communications network 1002 but rather by means of the WLAN access network 1003. If a useful data packet is received by the PDG/GGSN 1007 directly before the switching process by means of the UMTS communications network 1002, within the scope of the corresponding PDP context to be carried on, the switching process is not carried out until after the reception of this useful data packet.

The useful data which are stored in the second buffer 1006 are then passed on to the respective receiver in chronological order.

In step 1129, the GGSN 1131 deletes all the UMTS communications links which are no longer used, that is to say it terminates all the communications links, carried on by means of the WLAN access network 1003, of the UMTS communications network 1002. For this purpose, the GGSN 1131 carries out, for example, a “PDP context deactivation procedure” as described in 3GPP TSG-SA TS 23.060, General Packet Radio Service (GPRS); Service description; Stage 2 (Section 9.2.4.). Within the scope of this procedure, messages are exchanged between the GGSN 1131, the SGSN 1106 and the subscriber device 1101.

The essential differences between the methods explained with respect to FIG. 9 and the method described with respect to FIG. 11 for the handover from a UMTS communications network to a WLAN access network can be summarized as follows.

In the methods explained with respect to FIG. 9, after the setup of an IPsec tunnel, the subscriber device 901 decides which PDP contexts are to be carried on by means of the WLAN access network. For this reason, the subscriber device 901 is aware of more properties (compared with the methods explained with respect to FIG. 11) of the newly set-up communications link, that is to say of the communications link which potentially carries on the communications link which is provided for the handover, as a result of which the decision can be made more easily.

In the method explained with respect to FIG. 11, before the setup of the IPsec tunnel, the subscriber device 1101 decides which PDP contexts are to be carried on by means of the WLAN access network. In this way it is possible to avoid an IPsec tunnel being set up even though it is not necessary since the communications link for which it is set up will certainly not be carried on by means of the WLAN access network.

As explained, buffers are, as it were, created in the reception part of the subscriber device 1001 and in the reception branch of the PDG/GGSN 1007. In this way it is possible to compensate transit time differences which can occur during the switching over from the UMTS communications network to the WLAN access network so that no useful data are lost and the correct order of the useful data can be ensured.

As described, in the exemplary embodiments of a handover from a UMTS communications network to a WLAN which are explained with respect to FIG. 9, FIG. 10 and FIG. 11, the communications links which are carried on are set up before the respective switching processes. In this way it is possible to achieve very short switching delays, and data losses during the handover can be avoided.

1-12. (canceled)

13. A communications system comprising:
a first communications network;
a second communications network;
a third communications network;
a subscriber device; and
a network access device to which a network layer address is assigned, wherein the network access device is configured to permit access by the first communications network to the third communications network and access by the second communications network to the third communications network,
wherein the communications system has a communications link between the subscriber device and the third communications network by means of the first communications network and by means of the network access device, wherein the network layer address of the network access device is used during the transmission of data by means of the first communications link, and
wherein the network access device has a control device which is configured to release the first communications link and to set up a second communications link between the subscriber device and the third communications network by means of the second communications network and by means of the network access device, wherein the network layer address of the network access device is used during the transmission of data by means of the second communications link.

14. The communications system as claimed in claim 13, wherein the network layer address of the network access device is specified by means of an access point name during the transmission of data by means of the first communications link and/or during the transmission of data by means of the second communications link.

15. The communications system as claimed in claim 13, wherein the subscriber device has a transmission device which is configured to transmit a message to the network access device which has a request to release the first communications link and to set up the second communications link.

16. The communications system as claimed in claim 15, wherein the message is transmitted to the network access device by means of the first communications network.

17. The communications system as claimed in claim 15, wherein the message is transmitted to the network access device by means of the second communications network.

18. The communications system as claimed in claim 13, wherein the third communications network is the Internet.

19. The communications system as claimed in claim 13, wherein the first communications network is a WLAN communications network, and the second communications network is a UMTS communications network, or the second communications network is a WLAN communications network, and the first communications network is a UMTS communications network.

20. The communications system as claimed in claim 19, wherein the network access device has a WLAN network access device which has a function of a PDG of the WLAN communications network, a UMTS network access device which has a function of a GGSN of the UMTS communications network, and a memory which is accessed by the WLAN network access device and the UMTS network access device.

21. The communications system as claimed in claim 13, wherein the subscriber device and/or the network access device has/have a buffer which is configured to buffer, within the scope of the release of the first communications link and the setup of the second communications link, useful data which are transmitted by means of the first communications link and/or the second communications link.

22. A method for controlling a communications system which has a first communications network, a second communications network, a third communications network, a subscriber device and a network access device to which a network layer address is assigned and which permits access by the first communications network to the third communications network and access by the second communications network to the third communications network, wherein the method comprises:
using the network layer address of the network access device during the transmission of data by means of a first communications link which is provided between the subscriber device and the third communications network by means of the first communications network and by means of the network access device;
the network access device releasing the first communications link;
the network access device setting up a second communications link between the subscriber device and the third communications network by means of the second communications network and by means of the network access device; and
using the network layer address of the network access device during the transmission of data by means of the second communications link.

23. A network access device of a communications system comprising:
a first communications network;
a second communications network;
a third communications network;
a subscriber device,
wherein a network layer address is assigned to the network access device, and the network access device is configured to permit access by the first communications network to the third communications network and access by the second communications network to the third communications network; and
a control device which is configured to release a first communications link, wherein the first communication link is provided between the subscriber device and the third communications network by means of the first communications network and by means of the network access device, wherein the network layer address of the network access device is used during the transmission of data by means of the first communications link, and which control device is also configured to set up a second communications link between the subscriber device and the third communications network by means of the second communications network and by means of the network access device, wherein the network layer address of the network access device is used during the transmission of data by means of the second communications link.

24. A method for controlling a network access device of a communications system which has a first communications network, a second communications network, a third communications network and a subscriber device, said network access device being assigned a network layer address and permitting access by the first communications network to the third communications network and access by the second communications network to the third communications network, the method comprising:
the network access device releasing a first communications link, wherein the first communications link is provided between the subscriber device and the third communications network by means of the first communications network and by means of the network access device, and wherein the network layer address of the network access device is used during the transmission of data by means of the first communications link; and
the network access device setting up a second communications link between the subscriber device and the third communications network by means of the second communications network and by means of the network access device, wherein the network layer address of the network access device is used during the transmission of data by means of the second communications link.

25. A communications system comprising:
a first communications network;
a second communications network;
a third communications network;
a subscriber device; and
a network access means, which has a network layer address assigned thereto, for permitting access by the first communications network to the third communications network and access by the second communications network to the third communications network,
wherein the communications system has a communications link between the subscriber device and the third communications network via the first communications network and via the network access means, wherein the network layer address of the network access means is used during the transmission of data via the first communications link, and
wherein the network access means has a control means for releasing the first communications link and for setting up a second communications link between the subscriber device and the third communications network via the second communications network and via the network access means, wherein the network layer address of the network access means is used during the transmission of data via the second communications link.
